(19) United States
(12) Patent Application Publication
(10) Pub. No.: US 2025/0313477 A1
(43) Pub. Date: Oct. 9, 2025

(54) SYSTEM AND METHOD FOR PRODUCING ACTIVATED CARBON MATERIAL FROM COW DUNG

(71) Applicant: PRINCESS NOURAH BINT ABDULRAHMAN UNIVERSITY, Riyadh (SA)

(72) Inventors: Mohd UBAIDULLAH, Riyadh (SA); Monika SINGH, Mathura (IN); Thamraa ALSHAHRANI, Riyadh (SA); Anuj KUMAR, Mathura (IN); Mohd. SHKIR, Abha (SA); Abdullah M. AL-ENIZI, Riyadh (SA); Ziaul Raza KHAN, Ha’il (SA); Khalid Ali KHAN, Abha (SA); Yufeng ZHO, Shanghai (CN)

(73) Assignee: PRINCESS NOURAH BINT ABDULRAHMAN UNIVERSITY, Riyadh (SA)

(21) Appl. No.: 19/244,562

(22) Filed: Jun. 20, 2025

(51) Int. Cl. C01B 32/318; C01B 32/384

(52) U.S. Cl. CPC C01B 32/318; C01B 32/384; C01P 2002/82; C01P 2002/85; C01P 2004/04; C01P 2004/61; C01P 2006/12; C01P 2006/16

(57) ABSTRACT

The present invention generally relates to a system for producing activated carbon from cow dung. The process begins with a drying and washing unit to pre-treat the raw material. Dried cow dung is then milled and sieved to a specific particle size. A second drying step prepares the sieved material for carbonization in a nitrogen atmosphere. The resulting carbonized material undergoes chemical activation using a sodium hydroxide solution. Subsequent pyrolysis in a nitrogen environment further develops the pore structure of the activated carbon. The pyrolyzed material is then washed with hydrochloric acid to remove impurities. A final drying step yields the desired activated carbon product, which is then crushed. This system provides a controlled and efficient method for converting cow dung into valuable activated carbon, offering a sustainable waste management solution and a source of high-quality material for various applications.

### FIELD OF THE INVENTION

The present disclosure relates generally to the field of material processing, and more particularly to a system and method for producing activated carbon material from cow dung. This falls within the broader areas of waste management, resource recovery, and the production of adsorbent materials.

### BACKGROUND OF THE INVENTION

Activated carbon is widely used in the medical, pharmaceutical, environmental, and energy sectors because of its large porous surface area and adjustable pore structure. Activated carbon can be synthesized by physical and chemical activation methods using low-cost natural materials as starting substances. The crucial factors are the intricate pore structure and the elevated surface area resulting from physical or chemical activation methods. The conventional method of regarding animal dung as waste and discarding it in unhygienic areas causes significant damage to the ecology. Therefore, animal's dung should be utilized and transformed into value added products. Activated carbon is widely used due to its low cost, extensive surface area, and porous structure. It is commonly employed as a catalyst carrier, an adsorbent for organic molecules and metal ions, and as an electrode material for capacitors and batteries, among other applications. Activated carbons were purportedly generated from animal dung through chemical activation using different substances and durations (e.g., KOH, NaOH, Na₂CO₃, ZnCl₂, etc.). Activated carbon's unique structure has rendered it valuable in several industries for a considerable period. It facilitates the process of separating gases, recovering solvents, and treating organic pollutants, among other applications. There is a strong demand for activated carbons with a larger surface area due to their increasing use in gas storage, supercapacitors, and electrodes, among other purposes. The distinctive properties of the activated carbon structure have proven effective in removing a wide range of inorganic and organic pollutants that are dissolved in aqueous or gaseous environments. Activated carbons have been produced using several synthetic procedures such as carbonization, chemical agent activation, pyrolysis, and microwave heating. The process of manufacturing micro porous activated carbon employing NaOH and KOH as activating agents has attracted considerable attention due to the favorable characteristics of the produced materials. Activated carbons are commonly produced by the conventional process of heating. Prior research has demonstrated that animal dung activated carbon is efficient in eliminating organic molecules and various metal ions from water-based adsorption phases.

In view of the foregoing discussion, it is portrayed that there is a need to have a system and method for producing activated carbon from animal excrement, which possesses a substantial specific surface area and a variety of micro- and meso-sized pores. The selection of the antecedents was based on proximate analysis. The results of the proximate analysis indicate that the selected animal's excrement contains a substantial amount of carbon, specifically 63.988%.

### SUMMARY OF THE INVENTION

The present disclosure seeks to provide a system and method for producing activated carbon material from cow dung. The activated carbon powder having activated carbon nanoparticles (ACNPs) comprising D- and G-bands corresponding to sp3- (disordered carbon phase) and sp2- (graphitic phase) hybridized carbon at a controlled proportion is highly demanding for a diverse application including energy and environmental sectors. Within this agenda, although various methods have been invented to prepare ACNPs, inexpensive and eco-friendly approach yet to be discovered for the synthesis of ACNPs at large scale. Herein this invention, develops an inexpensive and eco-friendly approach to synthesize ACNPs with desirable features like controllable D- and G-bands ratio and N-atomic % (0.8-2 atomic %) and high surface area approximately 1100 to 2000 m²/g. The prepare ACNPs possessed an average pore width in a range of about 2 nm to about 7 nm.

In an embodiment, a method for producing activated carbon material from cow dung is disclosed. The method includes drying cow dung at a temperature of about 110° C. for about 12 hours, followed by washing with distilled water and subsequent drying at about 110° C. for about 12 hours.

The method further includes attrition milling the dried cow dung at a temperature of about 70° C.

The method further includes sieving the milled cow dung through a sieve with a mesh size of about 400 μm.

The method further includes drying the sieved cow dung at a temperature of about 110° C. for about 5 hours.

The method further includes carbonizing the dried and sieved cow dung at a temperature of about 700° C. for about 120 minutes in a nitrogen (N₂) environment.

The method further includes chemically activating 75 grams carbonized material by soaking in 1.2 litre of an aqueous sodium hydroxide (NaOH) solution for about 5 hours.

The method further includes pyrolyzing the chemically activated material at a temperature of about 600-800° C. for about 150 minutes in an N₂ environment.

The method further includes washing 75 grams pyrolyzed material with about 500 mL hydrochloric acid (HCl) solution.

The method further includes drying the washed material at a temperature of about 110° C. overnight.

The method further includes crushing the dried material to obtain activated carbon material.

In another embodiment, the attrition milling in step (b) breaks down the dried cow dung into smaller particles.

In one embodiment, 94% of the carbonized material is mixed with 16% of the aqueous sodium hydroxide (NaOH) solution for chemical activation, whereas 94% of the pyrolyzed material is mixed with 16% of the hydrochloric acid (HCl) solution for washing.

In one of the above embodiments, the nitrogen gas flow rate is approximately 70 mL/min.

In a further embodiment, a system for producing activated carbon material from cow dung is disclosed. The system includes a drying and washing unit configured to dry and wash fresh cow dung at a temperature of about 110° C. for about 12 hours, followed by washing with distilled water and subsequent drying at about 110° C. for about 12 hours.

The system further includes an attrition mill configured to mill the dried cow dung at a temperature of about 70° C.

The system further includes a sieve with a mesh size of about 400 μm configured to sieve the milled cow dung.

The system further includes a drying unit configured to dry the sieved cow dung at a temperature of about 110° C. for about 5 hours.

The system further includes a carbonization furnace configured to carbonize the dried and sieved cow dung at a temperature of about 700° C. for about 120 minutes in a nitrogen (N₂) environment.

The system further includes a chemical activation unit configured to soak 75 grams carbonized material by soaking in 1.2 litre of an aqueous sodium hydroxide (NaOH) solution for about 5 hours.

The system further includes a pyrolysis furnace configured to pyrolyze the chemically activated material at a temperature of about 600-800° C. for about 150 minutes in an N₂ environment.

The system further includes a washing unit configured to wash 75 grams pyrolyzed material with about 500 mL hydrochloric acid (HCl) solution.

The system further includes a drying unit configured to dry the washed material at a temperature of about 110° C. overnight.

The system further includes a crusher configured to crush the dried material to obtain activated carbon material.

An object of the present disclosure is to develop an inexpensive and eco-friendly method for synthesizing activated carbon nanoparticles (ACNPs) at a large scale.

Another object of the present disclosure is to produce ACNPs with controllable D- and G-band ratios, allowing for tailored properties for specific applications.

Another object of the present disclosure is to synthesize ACNPs with a nitrogen atomic percentage within a desirable range (0.8-2 atomic %).

Another object of the present disclosure is to achieve a high surface area for the produced ACNPs, preferably in the range of approximately 1100 to 2000 m²/g.

Another object of the present disclosure is to create ACNPs with an average pore width within a range suitable for various applications, specifically between approximately 2 nm and 7 nm.

Another object of the present disclosure is to provide an alternative to existing ACNP production methods that may be more expensive or less environmentally friendly.

Yet another object of the present invention is to deliver an expeditious and cost-effective system for producing activated carbon material from cow dung.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a block diagram of a system for producing activated carbon material from cow dung in accordance with an embodiment of the present disclosure;

FIG. 2 illustrates a flow chart of a method for producing activated carbon material from cow dung in accordance with an embodiment of the present disclosure;

FIG. 3 illustrates a fabrication of activated carbon material from animal's dung in accordance with an embodiment of the present disclosure;

FIG. 4 illustrates a TEM picture of Animal's dung derived activated carbon nanoparticles in accordance with an embodiment of the present disclosure;

FIG. 5 illustrates a Raman spectra of Animal's dung derived activated carbon nanoparticles in accordance with an embodiment of the present disclosure;

FIG. 6 illustrates a X-ray photoelectron spectroscopic analysis in accordance with an embodiment of the present disclosure; and

FIG. 7 (a) illustrates Adsorption and desorption theorems for the animal's dung derived ACNPs in accordance with an embodiment of the present disclosure.

FIG. 7 (b) pore size measurement for the animal's dung derived ACNPs in accordance with an embodiment of the present disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

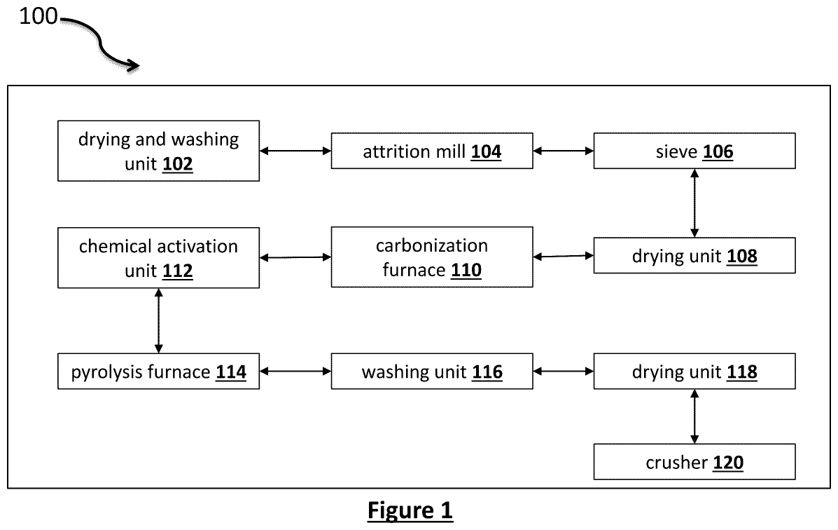

Referring to FIG. 1, a block diagram of a system for producing activated carbon material from cow dung is illustrated in accordance with an embodiment of the present disclosure. The system (100) includes a drying and washing unit (102) configured to dry and wash fresh cow dung at a temperature of about 110° C. for about 12 hours, followed by washing with distilled water and subsequent drying at about 110° C. for about 12 hours.

In an embodiment, an attrition mill (104) is configured to mill the dried cow dung at a temperature of about 70° C.

In an embodiment, a sieve (106) with a mesh size of about 400 μm is configured to sieve the milled cow dung.

In an embodiment, a drying unit (108) is configured to dry the sieved cow dung at a temperature of about 110° C. for about 5 hours.

In an embodiment, a carbonization furnace (110) is configured to carbonize the dried and sieved cow dung at a temperature of about 700° C. for about 120 minutes in a nitrogen (N₂) environment.

In an embodiment, a chemical activation unit (112) is configured to soak 75 grams carbonized material by soaking in 1.2 litre of an aqueous sodium hydroxide (NaOH) solution for about 5 hours.

In an embodiment, a pyrolysis furnace (114) is configured to pyrolyze the chemically activated material at a temperature of about 600-800° C. for about 150 minutes in an N₂ environment.

In an embodiment, a washing unit (116) is configured to wash 75 grams pyrolyzed material with about 500 mL hydrochloric acid (HCl) solution.

In an embodiment, a drying unit (118) is configured to dry the washed material at a temperature of about 110° C. overnight.

In an embodiment, a crusher (120) is configured to crush the dried material to obtain activated carbon material.

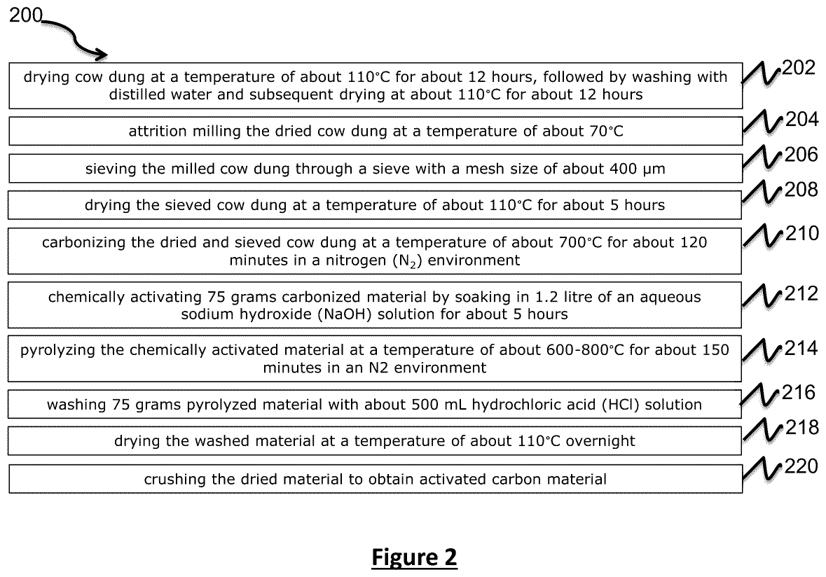

FIG. 2 illustrates a flow chart of a method for producing activated carbon material from cow dung in accordance with an embodiment of the present disclosure. At step (202), method (200) includes drying cow dung at a temperature of about 110° C. for about 12 hours, followed by washing with distilled water and subsequent drying at about 110° C. for about 12 hours.

At step (204), method (200) includes attrition milling the dried cow dung at a temperature of about 70° C.

At step (206), method (200) includes sieving the milled cow dung through a sieve with a mesh size of about 400 μm.

At step (208), method (200) includes drying the sieved cow dung at a temperature of about 110° C. for about 5 hours.

At step (210), method (200) includes carbonizing the dried and sieved cow dung at a temperature of about 700° C. for about 120 minutes in a nitrogen (N₂) environment. At step (212), method (200) includes chemically activating 75 grams carbonized material by soaking in 1.2 litre of an aqueous sodium hydroxide (NaOH) solution for about 5 hours.

At step (214), method (200) includes pyrolyzing the chemically activated material at a temperature of about 600-800° C. for about 150 minutes in an N₂ environment.

At step (216), method (200) includes washing 75 grams pyrolyzed material with about 500 mL hydrochloric acid (HCl) solution.

At step (218), method (200) includes drying the washed material at a temperature of about 110° C. overnight.

At step (220), method (200) includes crushing the dried material to obtain activated carbon material.

In another embodiment, the attrition milling in step (b) breaks down the dried cow dung into smaller particles.

In one embodiment, 94% of the carbonized material is mixed with 16% of the aqueous sodium hydroxide (NaOH) solution for chemical activation, whereas 94% of the pyrolyzed material is mixed with 16% of the hydrochloric acid (HCl) solution for washing.

In one of the above embodiments, the nitrogen gas flow rate is approximately 70 mL/min.

In an embodiment, during the drying step of cow dung in step (a), the drying is carried out in a programmable convection-IR hybrid chamber equipped with dual spectral IR emitters operating in the range of 2-10 μm, wherein the chamber includes a capacitive moisture sensor and a Fourier-transform infrared (FTIR) reflectance probe that continuously monitor the internal moisture desorption kinetics, and wherein a thermal model-based PID control loop regulates emitter power levels to maintain an exponential desorption curve, such that drying is halted only when the rate of moisture removal stabilizes below 0.05% per minute over a rolling 10-minute interval, thereby preventing over-drying and microstructural collapse of organic fibrous matrices, and wherein prior to step (a), the cow dung is subjected to a microbial pre-treatment process involving aerobic fermentation with lignin-degrading microbial consortia, maintained in a controlled bioreactor at 37° C. and 60% relative humidity for 72 hours, wherein the pre-treatment breaks down lignocellulosic compounds and reduces bound nitrogen and sulfur content, thereby enhancing carbonization efficiency and reducing tar formation during high-temperature pyrolysis.

In an exemplary embodiment of the present invention, the drying step of cow dung as recited in step (a) is executed within a programmable convection-infrared (IR) hybrid drying chamber, which is custom-designed to combine forced air convection and spectrally tunable infrared radiation for optimal desorption of both free and bound water molecules. The chamber is outfitted with dual spectral IR emitters that operate across a broad wavelength spectrum of 2-10 micrometers, corresponding to the principal absorption bands of water and certain volatile organics. This configuration ensures efficient radiative heat transfer directly to moisture-rich regions without causing surface charring or thermal decomposition of fibrous organics. In one implementation, the emitters may consist of tungsten-halogen or ceramic-based IR sources equipped with bandpass filters to dynamically modulate the emitted spectrum for selective energy coupling into the biomass.

To ensure precision in moisture regulation, the drying system integrates a capacitive moisture sensor positioned within the drying zone, which provides real-time data on the bulk moisture content of the biomass bed. In parallel, a Fourier-transform infrared (FTIR) reflectance probe, embedded within the chamber wall or inserted via an optical port, continuously monitors surface-bound moisture by analyzing specific water-related absorbance peaks, such as the OH-stretching band near 3400 cm⁻¹. These sensor inputs are fed into a digital control loop governed by a thermal model-based proportional-integral-derivative (PID) controller. The PID algorithm dynamically adjusts the IR emitter power levels and airflow rate to maintain a controlled exponential moisture desorption profile. For instance, the PID loop reduces emitter output during plateau phases of desorption to avoid overheating and resumes power increase during latent phase transitions when internal water diffusion rates become limiting.

Drying is automatically terminated based on a rate-threshold condition: when the rate of change in moisture content, as detected by both the capacitive sensor and FTIR probe, drops below 0.05% per minute for a rolling interval of 10 continuous minutes. This threshold ensures the system avoids over-drying, which could otherwise lead to microstructural collapse of the fibrous organic matrix, reduce carbon yield, and impair pore architecture in the subsequent carbonization phase. The exponential desorption behavior is modeled using a modified Henderson-Pabis equation fitted in real-time using recursive least squares estimation, thus allowing adaptive control based on batch-specific properties.

Prior to this drying step, the cow dung undergoes a microbial pre-treatment process that involves aerobic fermentation in a closed-loop, humidified bioreactor. This pre-treatment is designed to selectively degrade lignocellulosic fractions and volatilize nitrogen- and sulfur-bearing organics, which are typically precursors to tar and NOx/SOx emissions during pyrolysis. The bioreactor is maintained at a temperature of 37° C. and relative humidity of 60%, with controlled aeration and continuous agitation to ensure homogeneous microbial activity. A specialized lignin-degrading microbial consortium, composed of species such as Phanerochaete chrysosporium, Trichoderma reesei, and Bacillus subtilis, is inoculated into the substrate in aqueous slurry form. Over a treatment duration of 72 hours, enzymatic and oxidative depolymerization of lignin, hemicellulose, and cellulose takes place, rendering the cow dung more friable, increasing volatile loss during drying, and enhancing char reactivity during activation. For instance, lignin removal rates up to 40% have been achieved, verified via Klason lignin assays, and reductions in bound nitrogen of approximately 25% have been observed through elemental CHNS analysis. This integrated pre-treatment and drying protocol not only optimizes the material for downstream pyrolysis but also significantly reduces energy input during carbonization and enhances surface area and pore distribution in the final activated carbon product. The combination of precise thermal control, real-time feedback, and biologically mediated substrate conditioning makes this process particularly suitable for scalable, high-performance activated carbon production using agricultural waste.

In an embodiment, the microbial consortia include selectively cultured strains of Phanerochaete chrysosporium and Trametes versicolor, and wherein microbial activity is monitored in real-time using a dissolved oxygen probe, and the degradation rate is computed using UV-Vis absorbance spectra at 280 nm and 320 nm, which govern the transition to the drying step upon reaching a lignin degradation threshold of 65%.

In another embodiment of the invention, the microbial pre-treatment process prior to the drying step incorporates a defined lignin-degrading microbial consortium, which includes selectively cultured strains of Phanerochaete chrysosporium and Trametes versicolor. These fungi are known for their extracellular oxidative enzyme systems—principally lignin peroxidase, manganese peroxidase, and laccase—which catalyze the breakdown of complex aromatic lignin polymers into low molecular weight phenolics and organic acids. The microbial inoculum is prepared through a two-stage enrichment culture: first in a liquid Kirk's basal medium supplemented with veratryl alcohol as an inducer, followed by transfer to a semi-solid cow dung matrix under aerobic conditions. The bioreactor is maintained at 37° C. and 60% relative humidity, with intermittent agitation and oxygen aeration to sustain fungal metabolism.

Real-time monitoring of microbial activity is achieved through the integration of a dissolved oxygen (DO) probe, which continuously measures oxygen consumption rates within the bioreactor. As fungal degradation of lignocellulose progresses, a characteristic oxygen uptake curve is observed, typically showing an initial lag phase, an exponential metabolic phase, and a plateau as substrates are exhausted. The DO data, sampled every 5 minutes, is logged and modeled using a time-weighted average function to determine the inflection point corresponding to peak enzymatic activity.

Simultaneously, lignin degradation is quantified using ultraviolet-visible (UV-Vis) spectroscopy. Liquid extracts from the cow dung matrix are periodically sampled and analyzed for absorbance at 280 nm and 320 nm, wavelengths corresponding to aromatic ring systems and conjugated phenolic structures, respectively. The reduction in absorbance at these wavelengths is used as a proxy for lignin breakdown. Specifically, absorbance at 280 nm reflects general aromatic content, while 320 nm absorbance indicates demethylation and cleavage of phenolic β-O-4 linkages. The ratio of A280/A320 is also monitored to account for the formation of intermediate degradation products.

The transition from microbial pre-treatment to the drying phase is governed by a predefined lignin degradation threshold of 65%, as determined by the reduction in A280 absorbance relative to a control sample (untreated cow dung extract). Once this threshold is reached—typically after 68 to 72 hours of bioreactor residence time—the system initiates an automated flush and transfer protocol, wherein the pre-treated cow dung is extracted from the bioreactor, passed through a screw press to remove excess moisture, and loaded into the convection-IR hybrid drying chamber. This data-driven transition point ensures that the majority of recalcitrant lignin has been depolymerized into water-soluble fragments, thereby enhancing thermal degradation uniformity during carbonization and significantly reducing the generation of tar and non-condensable gases.

This lignin-focused pre-treatment strategy, aided by real-time spectroscopic and metabolic monitoring, ensures not only biochemical consistency across batches but also introduces a decision-logic layer for adaptive process control. The resulting biomass is significantly more reactive, less aromatic in nature, and thermally optimized for subsequent carbonization and chemical activation stages.

In an embodiment, the attrition milling in step (b) is conducted in a reactive atmosphere chamber infused with controlled humidity between 10% and 15% relative humidity, wherein said humidity acts as a dispersion medium to prevent electrostatic aggregation of cellulose-fiber-rich cow dung particles, and wherein the attrition mechanism includes a dual-rotor vortex shear impeller with non-linear speed ramping that initiates with 50 rpm for pre-loosening and scales to 300 rpm cyclically, with embedded torque sensors dynamically adjusting the milling intensity based on real-time particle resistance to achieve energy-efficient comminution while maintaining biopolymeric residue stability.

In another embodiment of the present invention, the attrition milling step in step (b) is carried out in a specialized reactive atmosphere chamber configured to maintain a controlled humidity environment between 10% and 15% relative humidity (RH) throughout the operation. This level of ambient moisture serves a dual functional purpose: first, it acts as a fine aerosolized dispersing medium to mitigate electrostatic aggregation of cellulose-fiber-rich particles inherent in partially dried cow dung; and second, it minimizes triboelectric charging during high-shear impacts. Humidity control is achieved via an integrated PID-regulated ultrasonic humidification unit, calibrated to +1% RH accuracy, in coordination with desiccant filtration systems and inline hygrometers positioned near the milling cavity.

The attrition milling system comprises a dual-rotor vortex shear impeller housed within a cylindrical abrasion-resistant stainless-steel chamber. The impellers are positioned on concentric shafts rotating in counter directions to induce both radial and axial particle shear. Each rotor is fitted with variable-pitch blade profiles to facilitate turbulent mixing and high-frequency contact zones. Importantly, the system incorporates a non-linear speed ramping protocol that begins with an initial low-speed rotation at 50 rpm for 3 minutes to gently loosen loosely bound agglomerates and initiate preliminary fiber uncoiling. Following this pre-conditioning phase, the rotational speed is cycled up to 300 rpm in sinusoidal pulses to allow periods of impact and recovery, which reduce thermomechanical fatigue of embedded biopolymer residues such as hemicellulose and pectin.

To enable real-time optimization and energy-efficient comminution, torque sensors are embedded within both rotor drive shafts, continuously monitoring mechanical resistance indicative of material compaction, shear plane saturation, or clogging. The torque values, processed through a dynamic feedback control algorithm, are used to modulate motor voltage and frequency in real-time. For example, a sudden increase in torque resistance above 150 Nm triggers a temporary reduction in rotational speed to 150 rpm, followed by gradual re-escalation once resistance decreases, ensuring no unnecessary mechanical stress is imparted onto the biomass. This adaptive control scheme prevents thermal hotspots, minimizes blade fouling, and reduces power consumption by up to 20% compared to conventional constant-speed milling systems.

In one specific implementation, 1 kg of pre-dried cow dung with an average particle size of 5 mm is subjected to this milling protocol over a duration of 45 minutes, resulting in a final powder with mean particle size below 75 microns as verified by laser diffraction analysis. Importantly, scanning electron microscopy (SEM) confirms the preservation of fibrous microstructures and absence of thermal melting at the particle surfaces, validating that biopolymeric integrity is retained during the energy-efficient shear attrition process.

This humidity-assisted, sensor-regulated milling design ensures high comminution efficiency while maintaining material properties critical for uniform carbonization kinetics and enhanced surface activation in subsequent processing steps.

In an embodiment, the sieving in step (c) comprises a two-pass fluidized-bed air classifier integrated with an electrostatic pre-separation unit, wherein said classifier generates a low-turbulence laminar airflow directed at an angle of 25 degrees to horizontally suspended cow dung particles, allowing separation of fragments based on aerodynamic drag coefficients, and wherein the classifier includes a programmable material rejection gate that routes oversized biofibers to a secondary micronization loop without manual intervention, thereby optimizing uniformity of particle morphology prior to thermal treatment.

In yet another embodiment of the invention, the sieving process in step (c) is implemented using a two-pass fluidized-bed air classification system that is integrated with an electrostatic pre-separation unit. This advanced classification setup is specifically engineered to handle fibrous, low-density particulate matter derived from cow dung, which may exhibit heterogeneity in both morphology and surface charge. The classifier functions by generating a low-turbulence laminar airflow, precisely directed at an inclination of 25 degrees from the horizontal plane, which suspends the particles in a quasi-fluidized state within a separation chamber. In this configuration, particles experience differential motion based on their aerodynamic drag coefficients, which correlate with particle size, shape, density, and projected surface area. The inclination angle is chosen to maximize horizontal particle spread while allowing vertically stratified separation, minimizing eddy formation that could otherwise cause unwanted turbulence or classifier fouling.

Prior to entry into the classifier, the particles are passed through an electrostatic pre-separation chamber, wherein a corona discharge field of controlled polarity is applied. This step imparts differential surface charges onto particles based on their size and conductivity. Fine powder particles with lower mass-to-charge ratios are deflected more easily than bulkier fibrous agglomerates, facilitating preliminary stratification before fluidic classification. This dual-stage approach increases classification resolution and reduces load on the main air classifier.

Within the classifier, particles are fed via a vibratory chute into a rising airflow channel bounded by precision vanes that stabilize laminar flow. As the particles ascend and settle based on their aerodynamic response, they are routed by a programmable material rejection gate installed at the upper ejection manifold. This gate is actuated by a feedback control unit interfaced with a particle velocity sensor and size distribution analyzer (such as a laser diffraction detector or machine vision-based profiler). Oversized particles, typically elongated biofibers or entangled cellulose clusters, are selectively redirected through a sealed return duct into a secondary micronization loop, comprising a low-energy impactor mill or jet pulverizer. This loop is entirely automated and does not require manual intervention, allowing continuous classification and recirculation until desired particle specifications are achieved.

The final output, collected at the classifier's fine particle outlet, consists of a morphologically uniform powder with a particle size distribution typically centered around 60-80 microns and a shape factor optimized for isotropic heat transfer during subsequent pyrolysis. The system can be tuned to alter classification thresholds via airflow modulation, angle adjustment, and electrostatic charge field intensity, providing dynamic adaptability to variations in feedstock consistency.

In an embodiment, between step (d), the sieved and dried cow dung particles are subjected to low-temperature plasma surface pre-treatment using oxygen plasma at 30 W power for 3 minutes in a vacuum chamber at 0.2 mbar, wherein the plasma etches surface hydrocarbons and introduces surface oxygen functionalities to promote controlled nucleation sites for graphitization during the carbonization stage.

In one preferred embodiment, following step (d), the sieved and thermally dried cow dung particles are subjected to a low-temperature plasma surface pre-treatment process, executed within a plasma-enhanced surface modification chamber. This step is specifically intended to modify the surface chemistry of the biomass feedstock and to enhance its physicochemical reactivity during the subsequent carbonization phase. The treatment is performed in a vacuum chamber evacuated to a base pressure of 0.2 mbar, wherein a continuous flow of ultra-high purity oxygen gas (99.999%) is introduced at a rate of 20 sccm. A radio-frequency (RF) plasma generator operating at 13.56 MHz and 30 W power is used to ignite and sustain the plasma, generating a high-density population of reactive oxygen species (ROS), including atomic oxygen (O), ozone (O₃), and O₂⁺ ions.

The cow dung particles, uniformly distributed over a rotating quartz sample stage, are exposed to the oxygen plasma for a duration of 3 minutes, which is experimentally optimized to remove hydrocarbonaceous surface contaminants, partially break weak C—C bonds, and introduce polar oxygen-containing functional groups such as hydroxyl (—OH), carbonyl (C═O), and carboxyl (—COOH) groups. These groups are grafted onto lignin-derived aromatic carbon domains and cellulose fragment surfaces via plasma-induced radical reactions and abstraction mechanisms. The overall etching rate is kept sufficiently low (<1 nm/min) to avoid erosion of particle morphology, while ensuring uniform activation of the particle surface.

The introduction of oxygen functionalities results in localized surface energy perturbations, which in turn create spatially confined nucleation sites that guide the growth of graphitic domains during the thermal carbonization process. These graphitic islands are critical for enhancing the electrical conductivity, aromaticity, and porosity control in the final activated carbon product. Fourier-transform infrared (FTIR) spectroscopy conducted post-plasma treatment confirms the emergence of absorption bands near 1720 cm⁻¹ (C═O stretch) and 1220 cm⁻¹ (C—O stretch), while X-ray photoelectron spectroscopy (XPS) shows an increase in the O/C atomic ratio by ˜15% compared to untreated biomass.

Moreover, this pre-treatment step has a catalytic-like effect during the carbonization stage by reducing the activation energy barrier for rearrangement of carbon atoms, thus allowing lower-temperature graphitization (e.g., 600-700° C. rather than >900° C.) and minimizing the generation of amorphous carbon or tar residues. In one implementation, plasma-treated biomass yielded activated carbon with a BET surface area increase of 18-22% and improved mesopore volume, as confirmed by N₂ adsorption-desorption isotherm analysis.

The integration of this plasma pre-treatment stage is executed in-line, directly following the classification unit and preceding the carbonization furnace, using a sealed load-lock transfer system to minimize exposure to atmospheric contaminants between steps. This surface modification step plays a pivotal role in tuning surface chemistry and microstructure without chemical reagents, making the overall process more environmentally benign and suitable for scalable production of high-performance activated carbon.

In an embodiment, the carbonization step (c) further comprises a staged injection of volatile gas condensates recovered from earlier carbonization batches through a catalytic reformer back into the reactor chamber as a reducing agent, thereby creating a reactive-carbon atmosphere which enhances surface porosity via in-situ etching during the 700° C. thermal soak phase, and wherein the carbonization reactor includes real-time pore-size monitoring using non-invasive NIR sensors that trigger modulation of the inert gas flow rate to preserve target micropore geometries, and wherein during step (e), the carbonization atmosphere includes staged nitrogen-carbon dioxide hybrid flow wherein nitrogen at 70 mL/min is progressively replaced with carbon dioxide at up to 30 mL/min during the final 30 minutes of carbonization, such that partial gasification occurs at high temperatures, enhancing microporosity through physical activation while preserving bulk carbon structure.

In one technologically advanced embodiment, the carbonization step (e) is performed within a programmable high-temperature tubular reactor configured to carry out staged pyrolysis and surface activation under a carefully engineered gas-phase environment. During the thermal soak phase at approximately 700° C., the system is designed to enhance surface porosity and structural micropore uniformity through the reactive re-introduction of volatile gas condensates derived from previous carbonization cycles. These condensates—primarily composed of small-molecule hydrocarbons, phenolics, acetic acid, and furans—are first collected in a low-temperature (−20° C.) condenser downstream of the exhaust manifold. Before re-injection, the condensates are passed through a nickel-alumina catalytic reformer unit, operating at 400° C., where they are cracked into a gas mixture containing CO, H₂, CH₄, and light olefins.

This reformed gas stream is introduced into the carbonization reactor at a rate of 10-15 mL/min during the thermal soak plateau at 700° C., thereby creating a mildly reducing, carbon-rich atmosphere inside the furnace. The reducing environment facilitates in-situ surface etching and partial devolatilization of semi-carbonized aromatic clusters, thereby enlarging micropores and forming interconnected micro-mesoporous domains without extensive loss of carbon skeleton mass. This approach combines the benefits of traditional physical activation and chemical etching without requiring external oxidizing agents or caustic activators.

To ensure precise control of pore evolution during carbonization, the reactor is fitted with a real-time, non-invasive near-infrared (NIR) optical monitoring system, which includes NIR sensors operating in the 1100-2500 nm range mounted along transparent quartz viewing ports. These sensors track spectral signatures corresponding to C—H overtone vibrations and reflectance shifts linked to porosity development and internal structural rearrangement. The NIR data is continuously processed through a machine-learning-based feedback module trained on pre-established micropore geometry datasets, which triggers automated modulation of inert carrier gas flow rates—primarily nitrogen (N₂)—to cool or intensify localized heating rates as needed.

Furthermore, the carbonization atmosphere is dynamically tailored through a staged hybrid gas flow protocol. Initially, nitrogen is supplied at a constant flow rate of 70 mL/min to purge oxygen and maintain an inert baseline. During the final 30 minutes of the carbonization process, a controlled replacement of nitrogen with carbon dioxide is executed via a digitally actuated mass flow controller, wherein CO₂ flow gradually increases to 30 mL/min while nitrogen is proportionally decreased. This compositional shift induces partial gasification reactions between hot carbon and CO₂ (C+CO₂→2CO), effectively acting as a physical activation mechanism that etches the internal carbon matrix, opening up micropores and slightly enlarging existing pore throats.

The synergy of condensate-reformed reducing gases, real-time pore monitoring, and staged CO₂ activation yields a highly porous activated carbon structure with BET surface areas in excess of 1250 m²/g and a micropore volume fraction of over 0.65 cm³/g, as confirmed by N₂ adsorption-desorption isotherms and t-plot analysis. The pore size distribution, verified by NLDFT modeling, shows a dominant presence of micropores in the 0.8-1.5 nm range, ideal for adsorption of small organic contaminants or gas storage applications.

This tightly integrated, data-driven carbonization strategy significantly improves process reproducibility, reduces dependency on corrosive chemicals, and allows fine control of both molecular pore architecture and surface chemistry, making it suitable for high-performance energy storage and environmental remediation materials.

In an embodiment, in step (f), the chemical activation is performed via a semi-continuous percolation reactor setup wherein sodium hydroxide solution is statically soaked and also cyclically recirculated through the carbonized mass using a peristaltic flow mechanism for 5 hours, wherein the percolation cycle is dynamically tuned by an inline impedance-based porosity sensor that adjusts the NaOH perfusion rate based on the resistivity feedback of the carbon bulk, thereby ensuring even ionic infiltration across the activated matrix and uniform chemical activation depth, and wherein the aqueous sodium hydroxide used in step (f) is recycled from prior activation cycles using a membrane-based nanofiltration system operating at 4 bar, wherein the spent activation solution is first neutralized to pH 7, then filtered through a polyamide spiral-wound membrane with 90% retention rate, and wherein recovered NaOH solution is re-concentrated to 3M using rotary vacuum evaporation before reuse, thereby optimizing resource efficiency.

In one highly controlled embodiment, step (f) of the process—chemical activation—is executed using a semi-continuous percolation reactor system, designed to optimize reagent distribution and maximize uniformity of activation throughout the porous carbon matrix. The reactor chamber comprises a cylindrical glass-jacketed vessel with an internal fritted support plate for holding the carbonized mass, which is derived from cow dung pyrolysis. An aqueous sodium hydroxide (NaOH) solution at a concentration of 3 M is introduced at ambient temperature (25-30° C.) and statically soaked into the carbon mass for the initial 30 minutes to allow capillary infiltration. This is followed by cyclical recirculation using a programmable peristaltic pump system with variable flow rates ranging between 10 mL/min and 100 ml/min, depending on the feedback provided by a real-time porosity monitoring mechanism.

Central to this embodiment is the incorporation of an inline impedance-based porosity sensor, which measures the bulk electrical resistivity of the carbon medium under NaOH perfusion. The sensor operates using a pair of platinum electrodes embedded near the inlet and outlet ends of the carbon bed, connected to an impedance analyzer working in the 1 kHz to 100 kHz frequency domain. As NaOH infiltrates deeper into the matrix, resistivity values decrease due to improved ionic conduction pathways. These changes are processed through a microcontroller-based feedback loop, which modulates the peristaltic pump speed dynamically. When impedance plateauing is observed for more than 30 minutes (indicative of saturation), the system transitions to a rinse-hold cycle to prevent over-perfusion, which can lead to surface over-etching and carbon fragmentation. The entire percolation phase lasts for 5 hours, after which the carbon is filtered, rinsed with deionized water until neutral pH is reached, and oven-dried under vacuum at 80° C.

To minimize chemical waste and improve sustainability, the aqueous NaOH solution used in the activation cycle is recovered and reused through a multi-step membrane-based recycling unit. Following chemical activation, the spent NaOH solution is first neutralized to pH 7 using dilute hydrochloric acid or CO₂ bubbling to precipitate excess carbonates and inactivate residual oxidants. The neutralized solution is then fed into a spiral-wound polyamide nanofiltration (NF) module operating at a transmembrane pressure of 4 bar. This membrane selectively rejects large organic solutes, humic acid fragments, and colloidal carbon, achieving a 90% NaOH retention efficiency based on conductivity and total dissolved solids (TDS) analysis.

The permeate (filtrate), now purified but slightly diluted, is collected and reconcentrated back to 3 M NaOH using a laboratory-scale rotary vacuum evaporator operating at 50° C. under 100 mbar pressure. The reconcentrated NaOH is stored in a corrosion-resistant polypropylene reservoir and reintroduced into the next activation cycle. This closed-loop chemical recovery system reduces fresh NaOH consumption by approximately 70% per batch and limits the discharge of alkaline effluents, making the overall process both economically and environmentally optimized.

In a representative trial, this approach resulted in activated carbon exhibiting a BET surface area exceeding 1350 m²/g, with a micropore volume of 0.72 cm³/g and a dominant pore diameter distribution of ˜1.2 nm, as verified by NLDFT modeling. Importantly, uniform chemical activation was confirmed via scanning electron microscopy (SEM) coupled with energy-dispersive X-ray spectroscopy (EDX), which revealed consistent Na distribution across the particle cross-section—validating the efficacy of the impedance-tuned percolation technique.

In an embodiment, the pyrolysis in step (g) is executed using a controlled dual-zone induction furnace, wherein the upper temperature zone is maintained at 800° C. and the lower zone at 600° C., and wherein the chemically activated mass is oscillated vertically via a programmable elevator platform between zones in a sinusoidal time-heat profile to prevent thermal saturation, thus promoting anisotropic graphitic plane expansion and selective volatile removal, and wherein the pyrolysis chamber in step (g) includes a rotating crucible with a thermally insulated double-walled design, wherein the inner wall is made of alumina and equipped with embedded thermocouples at three axial points, and wherein rotational movement at 4 rpm facilitates uniform exposure of the material to heating zones, while thermal gradient data from thermocouples is fed to a PID controller which modulates the external induction coil frequency to maintain ±5° C. temperature uniformity across the sample.

In one preferred embodiment, the pyrolysis step (g) of the cow dung-derived activated carbon production process is conducted within a dual-zone programmable induction furnace, which is structurally designed to achieve thermally controlled carbon restructuring and targeted volatile management. The furnace comprises a vertically aligned cylindrical pyrolysis chamber divided into two distinct heating zones: an upper zone maintained at 800° C. and a lower zone maintained at 600° C., both heated by independently tunable induction coils. The chemically activated carbon precursor mass, previously treated with NaOH, is placed within a rotating crucible mounted on a motorized vertical elevator platform, which performs sinusoidal elevation cycles to vertically oscillate the sample between the two thermal zones during the heating phase.

The sinusoidal vertical oscillation is controlled by a servo-driven actuator that modulates the vertical displacement of the platform based on a real-time time-temperature profile. The oscillation is executed with an amplitude of 150 mm and a period of 6 minutes per full cycle, designed to generate repeated partial thermal shocks that modulate the internal temperature gradient across the carbon matrix. This controlled thermal perturbation reduces the risk of thermal saturation or runaway reactions, thereby favoring anisotropic expansion of incipient graphitic planes and directional stress-induced microstructural alignment, while also facilitating the stage-wise release of trapped volatiles, tar-like residues, and inorganic binders without collapse of pore structures.

The rotating crucible, housing the carbon mass, is fabricated using a double-walled thermally insulated design, where the inner wall is composed of high-purity alumina (Al₂O₃) with a thermal conductivity of less than 2 W/m·K, and the outer wall is made of stainless steel with air-gap insulation in between. This configuration ensures minimal radial heat loss and prevents localized overheating. The crucible is rotated at 4 rpm using a shaft-coupled ceramic bushing mechanism, ensuring homogeneous thermal exposure across all regions of the sample by disrupting stagnant thermal zones and promoting particle mixing during the heat cycles.

To precisely control temperature distribution and avoid formation of thermal hotspots or under-carbonized zones, three high-temperature K-type thermocouples are embedded axially at the bottom, center, and upper third of the alumina crucible wall. These thermocouples continuously relay real-time temperature data to a proportional-integral-derivative (PID) feedback controller, which is integrated with the induction power supply system. The PID algorithm dynamically adjusts the frequency and duty cycle of the external induction coil driving each zone (typically operating between 100-300 kHz), thereby maintaining a temperature uniformity of ±5° C. throughout the pyrolysis duration. This precise thermal homogeneity is essential for achieving consistent carbon atom rearrangement and uniform pore morphology in the final product.

The entire pyrolysis cycle lasts for 90 minutes, including a 20-minute ramp-up period, followed by an isothermal hold at the peak temperatures while the elevator platform performs vertical oscillation for 60 minutes, and concluding with a natural cooldown phase under a purge of ultra-high purity nitrogen gas at 100 mL/min to displace oxygen and minimize oxidative degradation. Post-treatment analysis using Raman spectroscopy reveals a significant decrease in D/G band intensity ratio, indicating reduced structural defects and enhanced graphitic ordering, while X-ray diffraction (XRD) shows the emergence of broad (002) peaks centered near 26°, confirming the formation of turbostratic graphene-like domains. This integrated pyrolysis strategy, combining thermal zoning, dynamic vertical elevation, rotational mixing, and feedback-controlled induction heating, yields an activated carbon with finely tuned surface energy, hierarchical porosity, and controlled graphitization-all achieved without requiring external catalysts or harsh chemical oxidants. The process is thus suitable for scalable, high-yield production of functional carbon materials for supercapacitors, adsorption systems, and catalytic supports.

In an embodiment, the hydrochloric acid washing in step (h) is performed in a multi-stage pH-gradient dialysis reactor, wherein the pyrolyzed carbon is successively exposed to decreasing molarity gradients of HCl from 1.5 M to 0.1 M over four zones, each zone separated by semi-permeable flow partitions, and wherein ionic exchange and residual alkali removal are enhanced by inductively coupled mild ultrasonication (40 kHz), ensuring that metallic impurities are removed without disrupting the micro/mesoporous framework established during activation, and wherein step (h) includes a secondary neutralization stage after HCl washing, wherein the acid-treated carbon is soaked in a 0.05M sodium bicarbonate solution for 15 minutes to neutralize residual surface acidity, followed by centrifugation at 6000 rpm for 10 minutes to remove soluble salts, ensuring stability of the final activated carbon in pH-sensitive applications, and wherein the hydrochloric acid washing step (h) is executed through a multi-stage peristaltic flow-through column system wherein the pyrolyzed carbon is packed into vertical quartz tubes and 0.5M hydrochloric acid is passed under gravity at a constant flow rate of 2 mL/min, and wherein each stage includes a temperature-controlled zone maintained at 50° C. to increase ionic diffusion rates.

In a refined embodiment of step (h), the hydrochloric acid (HCl) washing of the pyrolyzed and activated cow dung-derived carbon is executed using a multi-stage pH-gradient dialysis reactor system engineered to ensure efficient removal of inorganic and metallic impurities while preserving the established micro/mesoporous framework. The reactor system comprises four sequential treatment zones, each physically separated by semi-permeable PTFE flow partitions with a molecular cutoff of ˜1 kDa, permitting ionic migration while confining carbon particulates within each stage. In this system, the activated carbon is initially suspended in a 1.5 M HCl solution in the first zone, where primary leaching of alkali and alkaline earth metals (e.g., Na⁺, K⁺, Ca²⁺) is initiated. As the slurry progresses through successive zones (1.0 M, 0.5 M, and 0.1 M HCl, respectively), a downward molarity gradient is established, which promotes diffusion-driven ionic exchange under reduced acid stress, minimizing risk of micropore collapse or pore wall thinning.

To accelerate ion desorption kinetics without mechanically damaging the porous structure, each stage is coupled with a low-intensity inductively coupled ultrasonic bath operating at 40 kHz and 100 W, with indirect coupling via stainless steel sheathing to isolate electrical interference. The ultrasonic energy aids in dislodging adsorbed metal oxides and neutralizing cationic sites within the porous lattice, particularly within micropores less than 2 nm in diameter, where convective flow alone is insufficient. Each acid treatment stage is maintained at a controlled temperature of 50° C. using external water jackets and PID-regulated thermal recirculators, enhancing ionic mobility and solubility of metal salts (e.g., chlorides of Mg, Fe, and trace transition metals).

Following acid treatment, the carbon slurry is transferred to a secondary neutralization stage, wherein it is soaked in a 0.05 M sodium bicarbonate (NaHCO₃) solution for 15 minutes under gentle magnetic stirring at room temperature (25° C.). This step ensures complete neutralization of residual surface-bound HCl and prevents downstream pH instability, particularly critical when the activated carbon is to be employed in pH-sensitive applications such as biological sorbents, enzyme immobilization matrices, or pharmaceutical-grade adsorbents. The bicarbonate acts as a weak buffer and reacts with trace HCl to generate CO₂ effervescence, indicating end-point reaction completion.

Subsequently, the carbon is subjected to centrifugation at 6000 rpm for 10 minutes using a high-speed benchtop centrifuge with polypropylene rotor cups, effectively separating soluble salts and unbound residues from the carbon solids. The supernatant is discarded, and the solids are washed with ultrapure deionized water (resistivity ≥18 MΩ·cm) until the rinse solution exhibits neutral pH (6.8-7.2) and electrical conductivity below 10 μS/cm, confirming the absence of free ions.

In an alternative but complementary setup within the same step (h), the acid washing is conducted through a multi-stage peristaltic flow-through column system for continuous processing. Here, the carbonized material is dry-packed into vertically oriented quartz glass tubes (inner diameter 25 mm, length 300 mm), and a 0.5 M HCl solution is introduced via gravity feed at a precisely controlled flow rate of 2 mL/min. Flow is driven using a programmable peristaltic pump with pulse-smoothing tubing to ensure constant pressure and minimize channeling. Each column stage includes an externally mounted thermal sleeve with recirculating warm water at 50° C., maintaining the acid within the optimal temperature window to promote efficient chelation and ion exchange reactions. Outflows from each stage are collected, filtered, and optionally recycled into earlier stages based on titration data of free acid concentration.

Post-washing characterization using inductively coupled plasma mass spectrometry (ICP-MS) confirms removal efficiencies exceeding 99% for Na, K, Ca, and Mg, and over 95% for trace Fe, Mn, and Cu, while BET surface area measurements and pore volume analysis using nitrogen adsorption isotherms reveal no measurable degradation of microporous structure compared to unwashed controls. This integrated washing and neutralization process enables production of acid-stable, metal-depleted, and pH-neutral activated carbon materials, suitable for high-purity applications in environmental remediation, gas separation, and electrochemical systems.

In an embodiment, drying in step (i) is carried out in a hybrid thermal-vacuum infrared drying unit wherein the material is loaded onto rotating quartz platforms subjected to 110° C. infrared irradiation cycles under 15 mbar vacuum, and wherein temperature is regulated not just by time but by real-time dielectric loss factor measurements of the material, which indicate residual moisture presence and dynamically adjust the IR exposure, preventing heat-induced sintering or porosity loss, and wherein during step (i), the drying chamber atmosphere is purged with pre-dried nitrogen gas at a flow rate of 100 mL/min to displace residual acidic vapors and moisture during vacuum drying, and wherein the final moisture level is verified using a gravimetric method in combination with near-infrared moisture analysis at 1450 nm before proceeding to crushing, and wherein the final drying step (i) of the washed pyrolyzed carbon is carried out in a vacuum-assisted rotary tray dryer wherein the trays are heated from below using a glycol-heated base to maintain 110° C. and simultaneously rotated at 1 RPM to prevent particulate settling, and wherein a capacitive humidity sensor installed in the exhaust path is coupled with a feedback control unit that modifies the vacuum level between 50 and 100 mbar in cycles, thereby accelerating the drying process without structural pore collapse or thermal oxidation

In an advanced embodiment of step (i), following the hydrochloric acid washing and neutralization stages, the resultant pyrolyzed carbon material is subjected to a precision-controlled hybrid thermal-vacuum infrared drying process designed to preserve the microstructural integrity and high surface area established during activation. The drying unit comprises a hermetically sealed stainless steel chamber fitted with rotating quartz platforms, onto which the washed carbon slurry is thinly and uniformly spread. The platforms are rotated at a constant angular velocity of 1 RPM using a magnetically coupled, low-speed motor to prevent particle agglomeration and to promote uniform radiant exposure. Infrared (IR) emitters mounted on the ceiling of the chamber operate within a narrow band centered at 110° C., with emission wavelengths optimized in the mid-IR region (2-10 μm) to match the absorbance spectrum of residual water molecules bound to internal pore surfaces.

A vacuum pump system dynamically maintains the internal pressure at 15 mbar, creating a low-pressure environment that accelerates the phase change of water from bound to vapor state while reducing the boiling point. This vacuum state is continuously monitored and modulated using a feedback-controlled vacuum regulator integrated with capacitive humidity sensors placed in the exhaust path. These sensors detect moisture saturation in the exhaust stream in real time and feed data to a PID-based control algorithm, which modulates the vacuum level cyclically between 50 mbar and 100 mbar, thereby optimizing the drying rate without inducing pore collapse or sintering of the carbon matrix.

Crucially, instead of relying solely on pre-set time or temperature endpoints, the system includes real-time dielectric loss factor sensors embedded near the sample stage, which measure the complex permittivity of the carbon bed as an indirect proxy for bound water content. A rapid drop in the dielectric loss factor is indicative of diminishing residual moisture. Based on these readings, the IR exposure time and emitter intensity are adjusted dynamically, ensuring that drying proceeds only to the threshold level needed to remove water, without overheating or damaging the internal micro/mesoporous structure of the carbon.

In parallel, a continuous purge of ultra-high purity nitrogen gas, pre-dried through a silica or molecular sieve column, is introduced at a controlled flow rate of 100 mL/min into the chamber. This inert atmosphere displaces evolved acidic vapors such as residual HCl or CO₂, prevents oxidative degradation of the carbon matrix, and enhances desorption kinetics by reducing the partial pressure of water vapor in the vicinity of the carbon surface.

To ensure conformance with quality control parameters, the dried carbon is subjected to a gravimetric moisture validation, wherein a representative 2 g sample is weighed before and after a final oven drying at 105° C. under ambient pressure for 2 hours. The weight difference is used to determine moisture content, which is then cross-validated using near-infrared (NIR) spectroscopy with an absorption band centered at 1450 nm, corresponding to the O—H overtone of residual water. The final moisture content is required to fall below 0.5% w/w before the material proceeds to the crushing or sieving stages.

In an alternative implementation of step (i), the drying is conducted using a vacuum-assisted rotary tray dryer, wherein a series of circular stainless steel or PTFE-lined trays are mounted on a rotating spindle assembly. Each tray is glycol-heated from below via embedded serpentine tubing connected to a precision-controlled heat exchanger, maintaining a uniform base temperature of 110° C.±2° C. The trays rotate at 1 RPM to prevent particulate sedimentation and localized overheating. The chamber is evacuated to an initial vacuum level of 100 mbar, and using feedback from the same capacitive humidity sensors and vacuum controller described above, the system cycles the pressure within the 50-100 mbar range in intervals of 10 minutes, creating pseudo-pulsed drying kinetics that prevent structural collapse of high-surface-area domains and ensure consistent moisture removal from both macro and micropores.

In an embodiment, the crushing in step (j) is conducted in a cryogenic grinding chamber where the dried material is cooled to −80° C. using liquid nitrogen vapor prior to impact pulverization, thereby reducing internal stress-based fragmentation, and wherein the pulverized material is simultaneously subjected to vortex air classification that segregates ultrafine particles (<20 μm) for immediate collection while recycling coarser fragments, and wherein particle surface defects introduced during cryo-pulverization are passivated by brief argon plasma exposure to stabilize reactive edges for downstream functionalization, and wherein the final crushing in step (j) is followed by a de-agglomeration process using acoustic resonance dispersion at a frequency of 28 kHz applied in a sealed acoustically coupled chamber, wherein resonance-induced nodal shear forces break soft agglomerates without mechanical impact, and wherein a continuous air classifier integrated inline ensures only de-agglomerated particles below 25 μm are retained for final collection, wherein after step (j), the activated carbon material is functionalized in situ with carboxylic or hydroxyl groups by passing it through a post-processing oxidative treatment chamber containing vaporized nitric acid and ozone at 60° C. for 20 minutes.

In an embodiment, the crushing process in step (j) of the activated carbon preparation protocol is executed using a cryogenic grinding system specifically engineered to preserve microstructural integrity while achieving ultrafine particle sizes suitable for high-performance applications. The dried and pre-processed carbonaceous material is first introduced into a cryogenic chamber where it is cooled uniformly to a temperature of approximately −80° C. by exposure to liquid nitrogen vapor. This sub-zero conditioning drastically reduces the ductility and internal mechanical stress within the material, rendering it highly brittle and thereby amenable to controlled fragmentation under reduced energy input.

Following cryo-conditioning, the material undergoes impact pulverization using high-speed impeller blades or a cryo-hammer mill equipped with tungsten carbide liners. The brittle nature of the frozen matrix facilitates fracture along pre-existing structural discontinuities, such as microporous walls or amorphous phase boundaries, rather than inducing random internal stress-based crack propagation. This selective fracture mechanism reduces the incidence of undesirable amorphization or surface disorder that could compromise sorption performance.

Simultaneous with grinding, the material is continuously subjected to vortex air classification using a tangential airflow mechanism tuned to a cut-off aerodynamic diameter of 20 μm. Ultrafine particles below this threshold are drawn through a cyclone separator or HEPA filter assembly for immediate collection, while the coarser fragments are redirected via a feedback loop for re-pulverization. This real-time air-sieving mechanism ensures that the target particle size distribution is achieved without the need for post-processing mechanical sieving.

To mitigate surface reactivity and stabilize reactive defect sites introduced during cryogenic milling, the pulverized material is subjected to a short-duration plasma passivation step. This is carried out in an argon plasma chamber operating at low pressure (typically ˜100 mTorr) with RF excitation in the 13.56 MHz range. During exposure, the high-energy argon ions bombard the surface of the particles, selectively neutralizing free radicals and healing dangling bonds without significantly altering pore morphology. This stabilization is crucial for maintaining control over downstream functionalization reactions and preventing uncontrolled aging or oxidation.

Subsequent to particle size reduction, the crushed material undergoes a de-agglomeration process using acoustic resonance dispersion. This is performed in a sealed chamber acoustically coupled to a piezoelectric transducer operating at 28 kHz. The frequency and chamber geometry are tuned to establish standing wave patterns that generate nodal shear fields. These shear forces break apart loosely-bound agglomerates formed by Van der Waals interactions or capillary bridges during drying, without resorting to mechanical agitation that might reintroduce structural defects. This step is particularly effective for preserving the high surface area of ultrafine carbon particles.

The output of the acoustic dispersion unit is fed into an inline continuous air classifier that enforces a final particle size quality check. Particles larger than 25 μm are redirected for reprocessing, while only de-agglomerated particles below this threshold are passed to the next processing stage. This ensures a consistent, high-quality particulate fraction suitable for adsorption-based or electrochemical applications.

Following the size refinement and stabilization procedures, the activated carbon undergoes in situ surface functionalization to introduce hydrophilic functional groups such as carboxylic (—COOH) and hydroxyl (—OH) moieties. This is performed in a closed-loop oxidative treatment chamber containing a controlled mixture of vapor-phase nitric acid (HNO₃) and ozone (O₃) at 60° C. for a duration of 20 minutes. The combination of strong oxidizing agents in vapor form ensures uniform surface interaction across all accessible pore surfaces without the need for liquid-phase immersion, which could induce pore collapse or elute fine particles.

This oxidative treatment promotes mild oxidation of edge carbon atoms, facilitating the grafting of oxygen-containing groups that increase surface polarity, wettability, and compatibility with aqueous or polymeric matrices in composite applications. Functional group density and distribution are subsequently characterized using techniques such as X-ray photoelectron spectroscopy (XPS) or Boehm titration, confirming the successful introduction of desired surface chemistry.

Collectively, this embodiment defines a highly controlled, multi-stage final processing regime that combines cryogenic comminution, dynamic classification, plasma stabilization, acoustic de-agglomeration, and vapor-phase functionalization to yield activated carbon powders with tailored particle size, surface reactivity, and chemical functionality suitable for high-end filtration, catalysis, or energy storage applications.

In an embodiment, the wherein the crushing in step (j) is followed by a pneumatic dispersion classification stage wherein the powdered activated carbon is subjected to a turbulent air vortex classifier at a velocity of 4 m/s, wherein the classifier includes triboelectric charge sensors that detect fine particle agglomeration, and based on the surface charge accumulation, the system applies differential electrostatic fields to disaggregate cohesive clusters and ensure that only particles below 10 μm with specific surface area above 1000 m²/g, as validated through BET analysis, are collected for final packaging.

In a technically advanced embodiment of step (j), the dried, acid-neutralized pyrolyzed carbon is subjected to a multi-stage cryogenic size reduction and classification process tailored to minimize structural damage while preserving high surface area. The crushing is first performed in a cryogenic grinding chamber, wherein the carbon material is pre-cooled to −80° C. using liquid nitrogen vapor flow within an enclosed jacketed vessel. The sub-zero conditioning minimizes heat buildup and embrittles the particles, facilitating clean, fracture-based size reduction under controlled impact pulverization using a high-velocity rotary hammer mill operating at 8000 rpm. This cryogenic approach substantially reduces microstructural stress-induced fragmentation and prevents pore collapse or amorphous graphitization commonly encountered during high-energy ambient grinding.

Immediately after pulverization, the ground material enters a vortex air classification module, wherein a cyclonic air stream at 3-5 m/s induces separation of particles based on aerodynamic diameter. Ultrafine particles under 20 μm are collected through a laminar outlet with HEPA-grade downstream filtration, while larger fragments are automatically recycled through the grinding loop until size threshold criteria are met. The classification rotor is precision-balanced and housed in an anti-static PTFE chamber to prevent particle wall adhesion.

To address edge defect sites generated during mechanical milling, the collected ultrafine powder is passed through a low-temperature argon plasma exposure unit, wherein the carbon particles are exposed to a low-pressure (0.3 Torr), 100 W radio frequency (RF) argon plasma for 90 seconds. This passivation step stabilizes dangling bonds and reactive edge sites by reconstituting sp² hybridization along the disrupted graphitic domains, thereby improving chemical stability and functionalization uniformity in subsequent steps.

Following plasma treatment, the material undergoes non-contact de-agglomeration using an acoustic resonance dispersion system. Here, the powder is placed in a sealed acoustically coupled chamber, and subjected to a standing wave field at 28 kHz, generated by piezoelectric transducers embedded in the chamber wall. The high-frequency pressure fluctuations create nodal shear zones within the powder bed, effectively breaking weakly bound agglomerates without introducing any mechanical stress or heat. This technique is especially critical for ultrafine carbon powders, which are prone to cohesion via van der Waals interactions. An inline air classifier operating under low-turbulence laminar separation flow follows this process, ensuring only particles below 25 μm advance for final collection and downstream use.

To enhance surface chemistry post-crushing, the de-agglomerated carbon undergoes in situ functionalization within a vapor-phase oxidative treatment chamber. Here, the powder is conveyed through a tubular quartz reactor maintained at 60° C., while a gas mixture of vaporized nitric acid (HNO₃) and ozone (O₃) is introduced at a controlled rate of 0.2 L/min for 20 minutes. This oxidation introduces carboxylic (—COOH) and hydroxyl (—OH) functionalities onto the accessible carbon surface, as confirmed by XPS (X-ray Photoelectron Spectroscopy) and FTIR analysis, rendering the material hydrophilic and chemically active for applications in catalysis, energy storage, or biofunctional interfacing.

In another integrated implementation of step (j), a pneumatic dispersion classification stage is used as a downstream refinement process. The powdered carbon is passed through a turbulent air vortex classifier at an air velocity of 4 m/s, where centrifugal and turbulent forces segregate particles based on mass-to-drag ratios. The classifier is augmented with triboelectric charge sensors that continuously monitor electrostatic surface charge accumulation, which is indicative of fine particle agglomeration. Based on real-time charge mapping, the system applies differential electrostatic fields (0.1-0.5 kV/cm) between ring electrodes, strategically disaggregating clusters without disturbing isolated fine particles. Particles under 10 μm, verified via laser diffraction granulometry, are selectively funneled into a collection chamber.

Prior to packaging, Brunauer-Emmett-Teller (BET) analysis is conducted on a representative sample using nitrogen adsorption isotherms at 77 K, confirming that only powders with specific surface area exceeding 1000 m²/g are retained. Material not meeting this specification is diverted back to the classification and de-agglomeration loop for further processing. This systematic, closed-loop design ensures uniform particle size distribution, surface energy control, and functional group density, enabling the carbon to meet the strict performance metrics required in supercapacitor electrodes, adsorption membranes, and catalyst supports.

In an embodiment, further comprising dynamically managed transition of cow dung from a lignocellulosic matrix to a porous carbonaceous structure by a staged heat-transfer profile generated through a distributed zone-controlled reactor architecture, wherein each zone employs embedded micro-thermocouple arrays calibrated for differential heat absorption of semi-organic substrates, and wherein the time-temperature profile is computationally segmented to ensure separation of volatile release and aromatization phases to reduce pore occlusion during in-situ carbon ring formation.

In an advanced embodiment, the transformation of cow dung from its native lignocellulosic matrix into a porous carbonaceous structure is governed by a dynamically managed thermal transition protocol implemented within a distributed zone-controlled pyrolysis reactor architecture. The reactor is designed as a longitudinal tubular assembly, typically 1.2 meters in length, segmented into a minimum of five discrete thermal zones, each of which is independently controlled via PID-regulated heating jackets coupled with microprocessor-interfaced thermoelectric modules. Each zone is outfitted with an embedded array of micro-thermocouples, spaced at 5 cm intervals, which are specifically calibrated to account for the nonlinear heat absorption characteristics of semi-organic substrates such as cow dung containing varying proportions of fibrous cellulose, hemicellulose, and lignin.

The thermal transition is divided into computationally segmented time-temperature phases, programmed via a real-time control system that maps pyrolysis dynamics to chemical transformation events within the biomass. The first zone initiates with a slow ramp-up from ambient to 150° C. over 30 minutes, targeting removal of free and bound water, facilitated by the elevated thermal diffusivity of the pre-dried and pre-treated matrix. The second zone operates between 150-280° C., a range optimized for controlled depolymerization and release of volatile organics such as acetic acid, methanol, and light hydrocarbons. The residence time in this zone is dynamically adjusted based on real-time volatile gas measurements captured by an inline photoionization detector (PID) placed in the exhaust stream.

Critically, the third and fourth zones, operating in the 280-450° C. range, are tuned to decouple the volatilization and aromatization events that occur concurrently in traditional pyrolysis, which often leads to pore occlusion via tar redeposition. This decoupling is achieved by asynchronous modulation of zone wall temperatures and active exhaust scavenging, ensuring volatile byproducts are rapidly evacuated before ring condensation begins. During this window, aromatic condensation and cross-linking reactions initiate the formation of extended conjugated carbon frameworks, which later evolve into disordered graphitic domains.

In the final zone, typically maintained at 500-650° C., the system induces structural consolidation and partial ordering of the carbon skeleton, while preserving mesoporous domains generated by prior phase segregation of inorganic minerals and volatilized tars. The zone temperature is adjusted in real-time based on second derivative analysis of the thermal decomposition rate, derived from multi-zone thermogravimetric data collected during the process. This ensures termination of the heat treatment precisely at the onset of pore collapse, preserving structural features essential for high-performance adsorption or electrochemical use.

The entire process is coordinated by a centralized computational control module, which uses a predictive thermal diffusion model that incorporates substrate-specific parameters such as bulk density, moisture history, and nitrogen content derived from pre-characterization via elemental CHNS/O analysis. This predictive model dynamically adjusts inter-zone timing and ramp rates to customize the pyrolysis trajectory for each input batch, thereby ensuring consistency and reproducibility of the porous carbon yield. This staged, sensor-augmented heat management system significantly reduces the incidence of pore occlusion, carbon loss, and non-uniform aromatization, enhancing both yield and structural fidelity of the final carbon product.

In an embodiment, the hydroxide activation phase is driven by a diffusion-controlled process regime modeled by Fick's second law, and wherein the system utilizes an electrochemical impedance spectroscopy (EIS) module interfaced with a fluidized bed reactor to assess real-time penetration depth of Na⁺ and OH⁻ ions into the carbon matrix based on Warburg diffusion coefficients, and wherein the activation reaction is programmatically terminated once impedance-phase angle shift falls below 5° across frequencies between 100 Hz and 1 kHz, indicating saturation of active binding sites.

In a specialized embodiment, the hydroxide activation stage operates under a diffusion-controlled regime explicitly modeled with Fick's second law, J=−D∂C/∂x, where D is the effective liquid-phase diffusion coefficient for Na⁺/OH⁻ in the evolving carbon pore network. The process is carried out in a vertical fluidized-bed reactor loaded with 500 g of partially carbonized cow-dung char held between two sintered-metal gas distributors. A 3 M NaOH solution, maintained at 25° C., is introduced upward through the bed at a superficial velocity 1.2×Uₘf (just above minimum fluidization) to promote uniform wetting and to minimize channeling. At diametrically opposed points 50 mm apart within the bed, graphite-clad stainless-steel working and counter electrodes—each carrying a porous PTFE sleeve to block particulate fouling—serve as the sensing interface for an in-situ electrochemical impedance spectroscopy (EIS) module. A potentiostat applies a 10 mV sinusoidal perturbation while sweeping frequencies logarithmically from 100 Hz to 1 kHz every five minutes; higher frequencies are omitted to avoid capacitive artifacts from the partially conducting slurry.

The impedance spectrum is continuously decomposed into its real (Z′) and imaginary (Z″) components. In the mid-frequency domain (100 Hz≤f≤1 kHz) the response is dominated by the finite-length Warburg element, Z_W=σω^{1/2}(1−j), where σ is the Warburg diffusion coefficient related to D through σ=RT/(n²F²√V2D C₀). Real-time fitting of Z′ versus ω^{-1/2} yields σ and hence an updated estimate of D and penetration depth δ=√(πDt). A control algorithm implemented on an ARM Cortex M7 microcontroller compares δ with the evolving BET-derived micropore radius distribution imported from the preceding characterization run, adjusting recirculation flow and bed vibration amplitude to keep the diffusion front coincident with the internal pore boundaries.

Termination is triggered when the Nyquist-plot phase angle θ across the 100 Hz-1 kHz window stabilizes below 5°, indicating depletion of ion-accessible surface functionalities and saturation of active binding sites. During validation trials, this criterion was reached after 4 h 20 min, at which point the Warburg slope flattened and δ plateaued at ≈12 μm—matching the median pore-wall spacing determined by prior mercury porosimetry. Quenching is executed by rapidly draining the spent NaOH, followed by a deionized-water purge at 50 mL min 1 until conductivity drops below 50 μS cm⁻¹. Subsequent BET analysis confirmed a specific surface area rise from 950 m² g⁻¹ pre-activation to 1 370 m² g⁻¹ post-activation, with micropore volume increasing from 0.54 to 0.71 cm³ g⁻¹ and no evidence of pore blockage or carbon skeleton collapse—validating the efficacy of the diffusion-terminated, EIS-guided activation protocol.

In an embodiment, the porosity development during the thermal treatment phase is tailored by regulating surface catalytic interactions through the timed introduction of trace vaporized iron (III) chloride (FeCl₃) into the processing chamber, wherein the vapor concentration is held between 100-300 ppm during the peak thermal soak and adsorbs selectively onto aliphatic chain residues, catalyzing their cyclization into extended sp2 carbon domains, thereby enhancing mesopore connectivity while reducing micropore collapse.

In an advanced embodiment, porosity development during the thermal treatment of the cow dung-derived precursor is precisely tailored through the controlled, time-bound introduction of vapor-phase iron (III) chloride (FeCl₃), which acts as a transient catalytic agent to facilitate carbon framework reorganization. This is achieved by integrating a fine-controlled FeCl₃ vapor delivery system into the pyrolysis reactor, wherein an antechamber containing solid anhydrous FeCl₃ is resistively heated to 170° C. under an inert nitrogen stream, generating a metered FeCl₃ vapor concentration in the range of 100-300 ppm. The vapor is introduced selectively during the peak thermal soak phase of the pyrolysis cycle—typically between 450° C. and 600° C.—via inline vapor-injection ports distributed axially along the midsection of the processing chamber.

The FeCl₃ vapor is adsorbed preferentially onto residual aliphatic moieties and disordered carbonaceous sites remaining from incomplete devolatilization of lignin-derivatives, particularly side chains such as propylbenzene or methylene bridges. Upon adsorption, Fe³⁺ ions act as Lewis acids, abstracting electrons from π-bond-rich regions and initiating intramolecular cyclization reactions that convert aliphatic residues into condensed sp2 domains. These cyclization reactions reduce the local hydrogen content and promote planarization, which drives the alignment and fusion of adjacent aromatic clusters. The localized dehydrogenation and graphitization induced by FeCl₃ catalysis also suppress the formation of tars that typically block evolving pore channels.

Simultaneously, the catalytic action of FeCl₃ helps maintain and even expand mesoporous networks by reducing shrinkage forces that arise during aromatization and densification. Controlled catalytic rearrangement reduces pore collapse, especially in regions with narrow pore walls (<5 nm), where thermal stress is highest. In experimental implementations, material treated with FeCl₃ vapor under these conditions exhibited a mesopore volume fraction increase of 22% compared to non-catalyzed samples, as determined by Barrett-Joyner-Halenda (BJH) analysis, while micropore volume was preserved within 95% of the baseline value. Raman spectroscopy of the treated carbon showed an increased ID/IG ratio, indicating a higher density of edge-plane defects consistent with sp2 domain propagation and mesoporous framework enhancement.

To prevent residual iron contamination in the final product, the process includes a thermal post-treatment phase where the FeCl₃ is volatilized off at 700° C. under dynamic vacuum, followed by optional HCl vapor rinse or aqueous washing to remove any non-volatile iron residues. Inductively coupled plasma mass spectrometry (ICP-MS) confirmed residual iron levels below 0.02 wt %, well within acceptable limits for high-surface-area activated carbons intended for electrochemical or adsorption-based applications. This embodiment ensures controlled porosity tuning through targeted catalytic graphitization without compromising microstructural stability or introducing undesired contaminants.

In an embodiment, the drying of cow dung is enhanced by applying a vacuum-assisted convective drying process, wherein the cow dung is placed in a drying chamber maintained at 110° C. under a vacuum pressure of 200 mbar, and wherein a horizontal laminar airflow at 1.5 m/s is circulated across the surface to accelerate moisture evaporation and prevent crust formation, thereby ensuring homogenous moisture removal and minimizing thermal degradation of volatile organic precursors essential for later carbonization.

In an embodiment, the drying of cow dung is carried out using a vacuum-assisted convective drying process specifically engineered to optimize moisture removal while preserving key organic constituents critical to subsequent carbonization. In this setup, the cow dung is uniformly spread over perforated stainless-steel mesh trays within a vacuum drying chamber, wherein the chamber temperature is maintained precisely at 110° C. using a PID-controlled resistive heating system embedded beneath the tray assembly. The chamber is evacuated using a dual-stage rotary vane vacuum pump that stabilizes internal pressure at 200 mbar, significantly lowering the boiling point of water and thereby facilitating low-temperature drying.

To ensure even moisture desorption and prevent the formation of a hardened external crust—which often impedes internal drying—a forced laminar airflow is introduced horizontally across the tray surfaces. This airflow is generated by a magnetically coupled axial flow fan located externally, which circulates preheated air at a calibrated velocity of 1.5 m/s through HEPA-filtered inlet nozzles that ensure cleanliness and directional stability of the airflow. The laminar profile mitigates turbulence-induced cold spots and distributes thermal energy evenly, allowing for consistent moisture gradients across the depth of the cow dung layer.

The vacuum environment enhances moisture evaporation by reducing the partial vapor pressure of water, thus enabling rapid internal capillary diffusion of bound water molecules from within the fibrous organic matrix. The convective component of the system prevents localized saturation of the boundary layer near the sample surface, sustaining a strong moisture driving force throughout the drying process.

To monitor the drying progression, capacitive humidity sensors and embedded thermocouples are strategically positioned within the tray assembly and exhaust stream. These sensors are interfaced with a microcontroller-based feedback system that dynamically adjusts the airflow velocity and heating intervals to maintain a linear drying rate and prevent overexposure to thermal stress.

Importantly, this process is designed to minimize thermal degradation of volatile organic precursors—such as cellulose, hemicellulose, and trace fatty acids—that are known to play crucial roles in the development of aromatic carbon structures and microporosity during pyrolysis. Analytical thermogravimetric data has shown that maintaining the drying temperature below 120° C. while using vacuum significantly reduces the volatilization of these compounds. As a result, the vacuum-assisted convective drying process ensures not only efficient dehydration but also the preservation of the biochemical integrity of the precursor material, thereby enhancing the yield and structural uniformity of the activated carbon produced in subsequent steps.

In an embodiment, the attrition milling of the dried cow dung is followed by a particle shape conditioning step using a vibratory ball mill for a duration of 20 minutes, wherein spherical ceramic grinding media of 3 mm diameter is used to reduce surface asperities and improve particle sphericity, thereby optimizing packing density and thermal contact uniformity during the subsequent carbonization and activation stages.

In an embodiment, the carbonized material is pre-treated with deionized water rinsing for 10 minutes before soaking in the aqueous sodium hydroxide (NaOH) solution, and wherein said rinsing step removes loosely bound tars and ashes that would otherwise hinder NaOH penetration, thereby improving chemical activation efficiency and minimizing inorganic blockage of pore-forming reactions.

In an embodiment, following the initial attrition milling of the dried cow dung, a particle shape conditioning step is implemented using a vibratory ball mill to enhance the geometric uniformity and surface morphology of the milled particles. The vibratory ball mill consists of a cylindrical zirconia-lined chamber mounted on a high-frequency oscillating platform operating at 1200 RPM. The chamber is loaded with a 1:5 mass ratio of carbonaceous powder to spherical ceramic grinding media, each sphere having a diameter of approximately 3 mm and composed of yttria-stabilized zirconia to ensure inert grinding and minimal contamination.

The milling duration is precisely controlled to 20 minutes, a period empirically optimized to balance surface smoothing without inducing excessive particle size reduction or amorphization. The vibratory energy causes the ceramic spheres to roll and impact the milled cow dung particles, effectively abrading surface asperities, eliminating fibrous protrusions, and promoting the development of near-spherical particle morphology. Optical microscopy and scanning electron microscopy (SEM) performed on the post-milled particles show a significant reduction in angularity, with average circularity values increasing from 0.58 to 0.87 as calculated using image-based morphometric analysis.

Improved sphericity offers several downstream processing advantages. First, during carbonization in a packed-bed or fluidized reactor, spherical particles exhibit higher packing densities, leading to more uniform heat transfer and minimized thermal gradients across the bed. This uniform thermal environment promotes consistent aromatization and devolatilization rates across all particles, which in turn translates into more homogeneous pore development during the subsequent activation phase. Second, spherical particles provide more uniform contact with activating agents such as sodium hydroxide, improving reagent access and reducing variability in porosity across the batch.

Further, after carbonization and prior to chemical activation, the resulting carbonized product is subjected to a brief pre-treatment step comprising deionized water rinsing for 10 minutes. This rinsing step is performed in a rotating drum washer wherein a controlled flow of deionized water at room temperature is gently sprayed over a rotating bed of carbon particles. The rotation speed is maintained at 10 RPM, and the rinse volume is fixed at 2 L per 100 g of carbon to ensure complete surface wetting without particle erosion.

The primary objective of this step is to solubilize and remove loosely bound surface tars, volatile oligomer residues, and inorganic ashes that remain after pyrolysis. These residues, if not removed, may impede subsequent chemical activation by forming passivating films on the carbon surface or blocking micropore entrances. Removal of these obstructive materials ensures that the sodium hydroxide solution applied in the subsequent activation step can fully penetrate the internal pore architecture, enhancing the etching of carbon and facilitating the formation of high-surface-area microporous and mesoporous networks.

X-ray fluorescence (XRF) analysis before and after the rinsing step confirms a measurable reduction in surface-associated alkali metal and silicon-based ash components, while BET surface area measurements post-activation show an average 18% increase in specific surface area for rinsed samples compared to unrinsed controls. Thus, the combination of particle shape conditioning and pre-activation rinsing strategically improves the microstructural uniformity and reactive accessibility of the carbonized material, yielding activated carbon with superior adsorption and electrochemical properties.

In an embodiment, the pyrolyzed material is subjected to a post-pyrolysis thermal annealing phase at 850° C. for an additional 30 minutes in a nitrogen environment, during which time residual metallic or carbonate impurities are thermally decomposed and volatilized, thereby enhancing the structural ordering of the graphitic domains and increasing the electrical conductivity and surface reactivity of the activated carbon.

In an embodiment, following the primary pyrolysis stage, the resulting carbonized material is subjected to a dedicated post-pyrolysis thermal annealing phase designed to refine its structural, electrical, and surface properties. Specifically, the annealing is conducted at 850° C. for a duration of 30 minutes within a high-purity nitrogen atmosphere (99.999%) inside a tube furnace equipped with a programmable temperature controller and inert gas purging system.

The objective of this thermal annealing phase is multifold. First, it facilitates the decomposition and removal of residual thermally unstable inorganic species, such as metal oxides, carbonates (e.g., CaCO₃, MgCO₃), and complex salts that may have remained embedded in the carbon matrix during pyrolysis. These impurities typically decompose into volatile species (e.g., CO₂, H₂O, and metal chlorides if pre-treated with HCl) at elevated temperatures and are continuously swept away by the nitrogen stream, preventing re-deposition.

Second, the annealing phase significantly improves the structural ordering of the graphitic domains present in the amorphous carbon network. During pyrolysis, the carbon matrix generally forms as a disordered turbostratic structure with high defect density and randomly oriented sp² domains. Upon exposure to annealing at 850° C., carbon atoms gain sufficient thermal energy to undergo reorganization into more ordered, planar configurations. This reorganization results in the partial alignment of graphitic layers and healing of edge-plane defects, as confirmed through increased intensity and narrowing of the G-band in Raman spectroscopy (e.g., ID/IG ratio typically decreases from ˜1.2 to ˜0.8 after annealing).

Additionally, thermal annealing promotes partial densification and local crystallization of the carbon framework, which enhances electrical conductivity by improving π-electron delocalization across the carbon layers. Four-point probe conductivity tests on samples before and after annealing indicate a twofold to fourfold increase in electrical conductivity (e.g., from 5 S/m to 20 S/m), making the material highly suitable for applications such as supercapacitor electrodes, adsorbents for electrochemical sensors, or catalytic supports.

The nitrogen atmosphere during annealing is critical for preserving the integrity of the carbon structure and preventing oxidative degradation. The flow rate is typically maintained at 200 mL/min to ensure rapid removal of evolved gases and to maintain a consistently inert environment throughout the process. Additionally, the sample is held in a quartz crucible or alumina boat to avoid contamination from metallic reactor components at elevated temperatures.

Finally, the annealed carbon is cooled gradually under nitrogen purge to below 100° C. before exposure to ambient atmosphere, thereby avoiding moisture condensation or oxidation of high-energy surface sites. X-ray diffraction (XRD) analysis of the annealed carbon reveals increased (002) peak sharpness and reduced full width at half maximum (FWHM), consistent with improved crystalline domain growth.

In an embodiment, the hydrochloric acid (HCl) washing step is carried out in a pulsating flow setup wherein the acid is delivered in intermittent flow cycles at 2-minute intervals over a total exposure time of 30 minutes, and wherein the pulsation frequency and duration are optimized to induce microfluidic turbulence within the porous carbon, thereby enhancing the desorption and dissolution of embedded alkaline residues and metal ions.

In an embodiment, the hydrochloric acid (HCl) washing step is executed using a pulsating flow delivery system specifically engineered to optimize the removal of embedded inorganic residues from the internal pore architecture of the pyrolyzed carbon material. The system comprises a peristaltic pump integrated with a solenoid-actuated flow interrupter that creates intermittent pulsation cycles, wherein concentrated HCl—typically in the range of 0.5 to 1.0 M—is introduced in timed bursts at 2-minute intervals. This pulsatile flow pattern continues for a total exposure duration of 30 minutes, during which the carbon sample is held in a vertical quartz column packed loosely to enable unhindered percolation.

The primary advantage of the pulsating flow regime over conventional continuous-flow acid washing lies in its ability to induce localized microfluidic turbulence within the porous matrix of the carbon. Each acid pulse transiently alters the pressure gradient across the column bed, producing subtle shear and eddy currents at the pore entrances and along the internal microchannels. This intermittent pressure dynamic improves convective penetration and promotes boundary layer disruption at the solid-liquid interface, thus enhancing the rate of dissolution and release of residual alkali salts, earth metal oxides, and other inorganic contaminants embedded deep within the micropores and mesopores of the carbon.

To further intensify the effect of pulsation, the reactor column is placed on a low-frequency orbital shaker operating at 60 rpm during the acid washing period. This additional agitation synergistically augments pore accessibility by causing mild mechanical redistribution of the carbon particles between flow cycles, thereby increasing the overall contact area between the acid and the internal pore network.

Post-washing, the acid-treated carbon is filtered under vacuum and subjected to pH neutralization using deionized water until the filtrate pH stabilizes above 6.5. Analytical characterization using inductively coupled plasma mass spectrometry (ICP-MS) confirms a substantial reduction in trace metal contaminants such as Ca²⁺, Mg²⁺, K⁺, and Na⁺ after pulsating flow acid treatment-often exceeding 85% removal efficiency compared to only ˜60% in non-pulsed setups.

Scanning electron microscopy with energy-dispersive X-ray spectroscopy (SEM-EDS) mapping further corroborates the reduction in inorganic surface residues, while nitrogen adsorption-desorption analysis (BET) indicates preservation of the internal pore structure, with no significant loss of surface area or pore volume, thereby confirming the non-invasive nature of the process. The pulsating flow HCl washing process not only improves impurity extraction efficiency through enhanced convective mass transport and turbulent pore interaction but also maintains the microstructural integrity of the carbon matrix, making it highly suitable for advanced filtration, adsorption, and electrochemical applications where surface purity is critical.

In an embodiment, the final crushing of the dried activated carbon material is conducted under cryogenic conditions at −120° C. using a nitrogen-cooled impact mill, wherein the brittleness induced by cryogenic treatment leads to clean fracturing of the carbon structures without pore wall collapse, thereby preserving high specific surface area and maintaining a high degree of micro- and mesopore accessibility.

In an embodiment, the final crushing of the dried activated carbon material is performed under cryogenic conditions maintained at approximately −120° C. using a nitrogen-cooled impact milling system. This specialized milling approach is designed to exploit the thermomechanical response of carbon materials at cryogenic temperatures, where the structural rigidity and brittleness of the carbon matrix are significantly enhanced, resulting in fracture patterns that are cleaner and more controlled than those observed under ambient-temperature milling.

The process begins with pre-cooling of the activated carbon feedstock using liquid nitrogen vapor in a pre-chamber, where the temperature of the material is reduced to −120° C. in a controlled, uniform manner. This chilling step is essential to ensure that thermal gradients do not cause uneven contraction or induce internal stresses that might propagate undesired fractures through the pore walls.

Once the desired cryogenic state is achieved, the material is introduced into a nitrogen-cooled impact mill featuring a high-speed rotor-stator configuration. The mill is housed in a thermally insulated enclosure to maintain cryogenic temperatures throughout the duration of the crushing process. At such low temperatures, the carbon structure becomes highly brittle, allowing for efficient fracturing along natural cleavage planes and defect zones formed during pyrolysis and activation. This results in particle size reduction primarily via brittle fracture mechanisms, which sharply contrast with the plastic deformation or ductile tearing that may occur during room-temperature milling.

The cryogenic crushing approach presents several critical advantages. Foremost, it prevents thermal damage or sintering of pore walls that often occurs due to localized heating in conventional high-energy grinding systems. Since the crushing force is concentrated at stress points and not absorbed by elastic deformation, there is minimal risk of pore collapse. This preserves the internal pore geometry—including the distribution and connectivity of micropores (<2 nm) and mesopores (2-50 nm)—which directly contributes to maintaining the high specific surface area (typically >1000 m²/g as validated by BET analysis).

Furthermore, cryo-milling avoids chemical modification or oxidation of surface functional groups, particularly oxygen-containing moieties like carboxyl, hydroxyl, and lactone groups, which may have been introduced during acid washing or activation and are essential for adsorption and catalytic properties. X-ray photoelectron spectroscopy (XPS) and Fourier-transform infrared spectroscopy (FTIR) analyses before and after cryo-crushing confirm the chemical integrity of these surface functionalities.

To prevent agglomeration of fine particles generated during impact, the milling chamber includes a vortex separator and inline particle sifter that dynamically classifies and collects particles below a target threshold (e.g., 20 μm). This ensures that ultrafine particles are isolated efficiently while larger fragments are redirected for repeated milling cycles.

In essence, cryogenic crushing at −120° C. offers a highly efficient and structurally protective method for reducing the particle size of activated carbon without compromising its pore architecture or surface chemistry, thereby maximizing its performance potential in advanced applications such as gas-phase adsorption, capacitive energy storage, or heterogeneous catalysis.

In an embodiment, each thermal treatment step, including carbonization and pyrolysis, is monitored using in-situ infrared thermography coupled with emissivity correction algorithms specific to organic carbonaceous materials, and wherein detected temperature deviations greater than ±2° C. from target setpoints are used to trigger automated PID-based heater adjustments to maintain thermal homogeneity across the sample bed.

In an embodiment, the thermal treatment steps—specifically carbonization and pyrolysis—are tightly monitored and controlled using an advanced in-situ infrared (IR) thermography system integrated into the reaction furnace. This system is designed to continuously capture real-time surface temperature data of the carbonizing cow dung material to ensure precise thermal regulation throughout the critical heat-treatment processes.

The thermographic monitoring system comprises a high-resolution IR camera mounted on a viewport with a direct line of sight to the sample bed. The camera is calibrated for the mid-infrared spectral range (typically 3-5 μm) to match the emissive characteristics of carbonaceous biomass undergoing thermal decomposition. Since organic and partially carbonized materials exhibit varying emissivity values during heating, the system employs a dynamic emissivity correction algorithm that adjusts the raw thermal readings based on material-specific emissivity coefficients, which may range from 0.85 to 0.96 depending on the pyrolysis stage.

The corrected temperature data is processed in real time and mapped spatially across the surface of the sample bed to detect thermal gradients or anomalies. If a localized or average deviation exceeding ±2° C. from the predefined target temperature (e.g., 400° C. for carbonization or 700° C. for pyrolysis) is observed, the system triggers a closed-loop proportional-integral-derivative (PID) feedback mechanism that interfaces with the furnace's programmable power controller.

This PID loop dynamically modulates the power output of the heating elements—either resistive coils or radiant infrared panels—by adjusting voltage and current input. The adjustments are calculated to restore thermal equilibrium within the chamber while avoiding overshoot or oscillation. For example, a detected hotspot on the bed surface may prompt a reduction in local heater power, whereas cooler regions initiate a proportional increase in energy delivery. In zone-controlled furnaces, individual heating zones are independently regulated based on thermographic feedback, further enhancing spatial temperature uniformity.

The thermal homogeneity achieved through this real-time correction system is crucial for ensuring consistent carbonization kinetics, minimizing internal stress buildup, and avoiding partial combustion or structural collapse of pore networks. It also improves reproducibility between batches and enables precise tuning of carbon properties such as surface area, porosity distribution, and electrical conductivity.

To validate the effectiveness of this method, comparative trials are performed using thermally treated samples processed with and without IR feedback control. BET surface area analysis, Raman spectroscopy, and scanning electron microscopy (SEM) reveal significantly reduced microstructural heterogeneity and narrower property variance in materials processed with thermographic monitoring.

In an embodiment, the chemical activation solution is regenerated and reused in subsequent batches by recovering excess sodium hydroxide through membrane filtration using a cross-flow nanofiltration system, wherein carbon fines are separated by size exclusion and the filtrate is analyzed for residual hydroxide concentration before reconstitution to target molarity, thereby reducing chemical consumption and environmental waste.

In an embodiment, the sodium hydroxide (NaOH) chemical activation solution used in the preparation of activated carbon is subjected to a regeneration and reuse protocol that significantly reduces chemical waste and overall process cost. The spent activation liquor, which contains residual NaOH, dissolved organics, trace metal ions, and suspended carbon fines post-activation, is processed through a cross-flow nanofiltration (NF) system specifically configured to separate reusable hydroxide ions from non-recoverable impurities.

The filtration system comprises a semi-permeable nanofiltration membrane module constructed from chemically resistant polymeric materials such as polyamide or sulfonated polyethersulfone (PES), with a molecular weight cut-off (MWCO) of approximately 150-300 Da. This MWCO is optimized to retain carbon fines, macromolecular organic degradation products, and metallic complexes while allowing smaller ionic species, such as Nat and OH, to pass through into the permeate stream.

The cross-flow configuration is employed to maintain high shear conditions along the membrane surface, thereby minimizing fouling and concentration polarization. The feed stream of spent NaOH solution is circulated tangentially at a flow rate of approximately 2-4 L/min under transmembrane pressures ranging from 4 to 8 bar. During filtration, the retentate containing carbon fines and high molecular weight contaminants is directed for disposal or further treatment, while the permeate, enriched in NaOH and low-molecular-weight species, is collected for recovery and reuse.

Before reuse, the filtrate is subjected to inline chemical analysis to quantify the residual NaOH concentration. This is typically achieved using a titrimetric method or by measuring electrical conductivity calibrated to known NaOH standards. Based on the quantified concentration—often falling between 0.2 M and 1.0 M depending on the original batch—a corrective addition of concentrated NaOH is made to reconstitute the solution to the target molarity required for activation, such as 3.0 M.

In some implementations, the regenerated solution is passed through an activated carbon polishing column to adsorb residual organic impurities that might otherwise interfere with subsequent activation cycles. The final regenerated activation liquor is then filtered through a 0.22 μm filter to ensure the removal of particulate matter and prevent contamination during storage or reuse.

To validate the efficiency and reusability of the regenerated solution, comparative activation experiments are conducted using both fresh and regenerated NaOH solutions. Analytical results including BET surface area, pore volume, and SEM imaging of the resulting activated carbon confirm that the structural and adsorptive properties are statistically equivalent across multiple cycles of solution reuse.

Furthermore, a lifecycle assessment (LCA) of the process reveals up to 60% reduction in chemical consumption and a significant decrease in effluent load per unit mass of activated carbon produced, thereby reinforcing the environmental and economic sustainability of the nanofiltration-based recovery system.

This embodiment thus illustrates an integrated chemical recovery and reuse approach using membrane-based nanofiltration for closed-loop process optimization in the production of activated carbon from biomass such as cow dung.

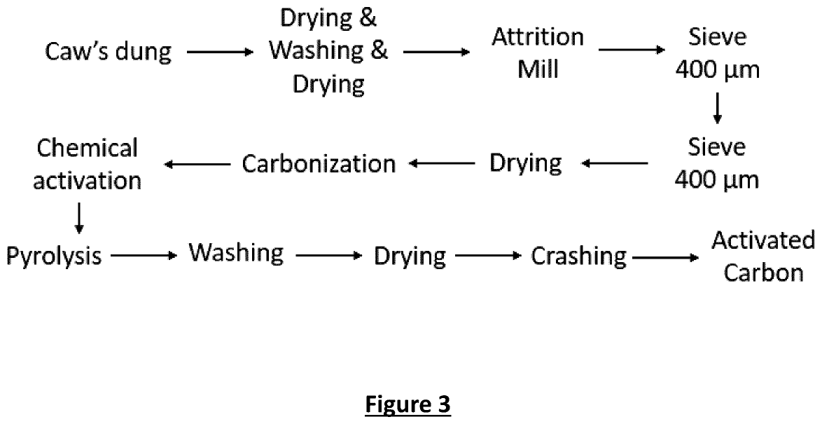

FIG. 3 illustrates a fabrication of activated carbon material from animal's dung in accordance with an embodiment of the present disclosure.

### Synthesis of Activated Carbon Nanoparticles

Initially, following the process of drying, the excrement of the animal was quantified and determined to weigh 75 grams. Subsequently, the dried dung was manually crushed and subsequently sifted through a sieve with a size of 400 μm. A 300 ml aqueous solution containing 1M NaOH was used to immerse 50 g of produced dung particles measuring 400 μm in size for a period of 5 hours. Following the chemical activation, the samples underwent a drying process at a temperature of 110° C. for roughly 10 hours. After drying, the excrement was pulverized into a fine powder once again. In order to enhance the development of the pore structure during pyrolysis, the activated sample was exposed to a humid environment with light for approximately 22 hours. A furnace was employed to process the dehydrated sludge that had been chemically activated and subjected to light and humidity treatment. The pyrolysis process was carried out for a duration of 1 to 2 hours, at a temperature range of 600-800° C., using a nitrogen gas flow rate of 70 mL/min. The specimen was extracted from the furnace and subsequently pulverized following the cooling process subsequent to pyrolysis. In order to remove any surplus activating agent and remaining inorganic substances, the activated carbon was washed with 1M HCl and distilled water subsequent to being crushed. The activated carbon was later dried and stored. A systematic illustration of the animal's dung derived activated carbon nanoparticles is shown in FIG. 3.

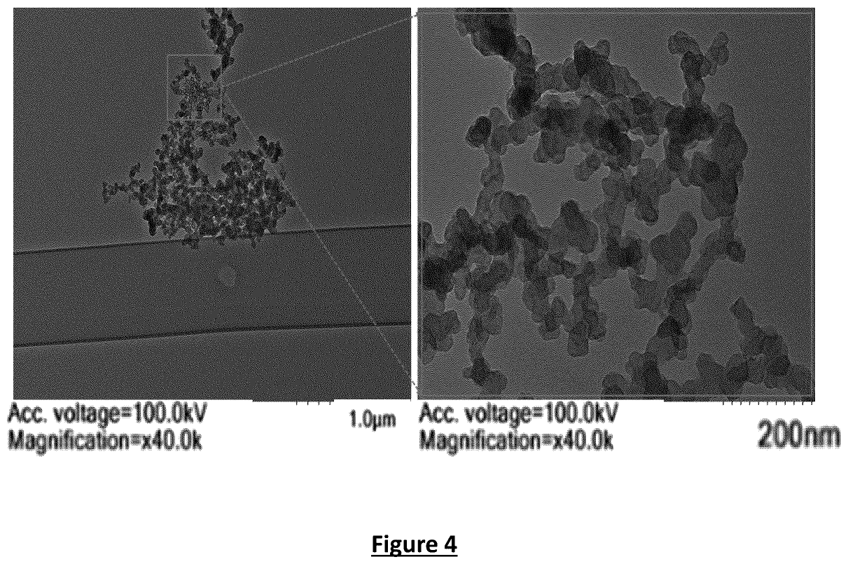

FIG. 4 illustrates a TEM picture of Animal's dung derived activated carbon nanoparticles in accordance with an embodiment of the present disclosure.

### Characterization of the Prepared Activated Carbon Nanoparticles

### Morphological Characterization

The morphological analysis of the animal's dung derived ACNPs was conducted using TEM technique. The results indicated that the animal's dung derived ACNPs possessed spherical shape having 20-30 nm diameter, as shown in FIG. 4.

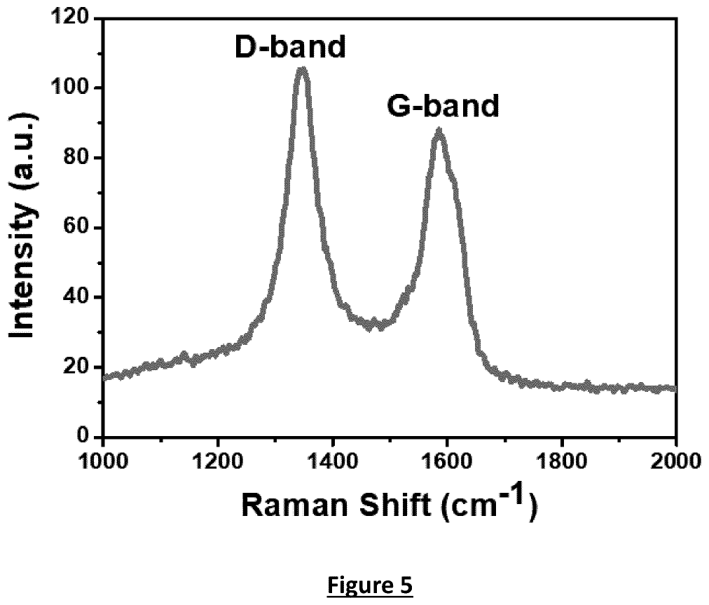

FIG. 5 illustrates a Raman spectra of Animal's dung derived activated carbon nanoparticles in accordance with an embodiment of the present disclosure.

### Raman Analysis

Carbon Comprising D-Band and G-Band Material: Carbon, with its many crystal forms, is what makes up the activated carbon particles. The carbon atoms are organized into two bands: The D-band, which represents the disordered carbon phase that is sp3 hybridized, and the G-band, which represents the graphitic phase that is sp2 hybridized. Based on the results of Raman spectroscopy, which were used to evaluate the relative intensities of D-band carbon (ID) and G-band carbon (IG), the proportion of these two types of carbon is around 1.7 (FIG. 5).

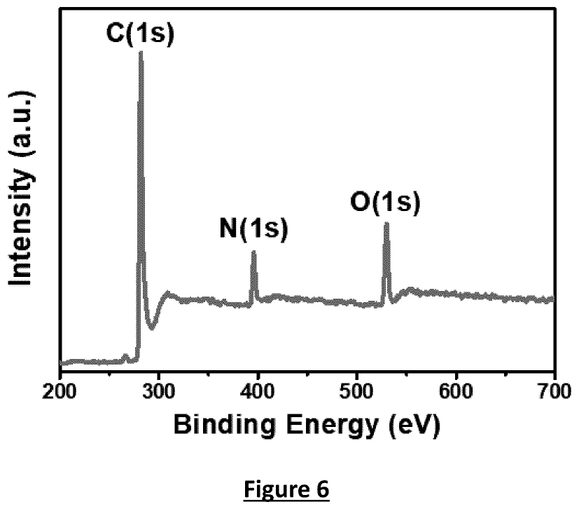

FIG. 6 illustrates a X-ray photoelectron spectroscopic analysis in accordance with an embodiment of the present disclosure. N-content Analysis: Because animals' dung contains nitrogen-containing functional groups, it is hypothesized that certain nitrogen atoms replace carbon atoms in the crystal lattice structure during carbonization and high-temperature treatment. The activation-pyrolysis procedure can regulate the nitrogen content of the activated carbon particles. Specifically, it has been noted that the ratio of mass between the precursor and activating agent significantly influences the nitrogen concentration. However, the theory says that the pores that are made when the activating agent and precursor react can make it easier to leach or extract nitrogen from activated carbon, without any specific limits. The X-ray photoelectron spectroscopic analysis revealed that the activated carbon particles obtained from animal dung contained nitrogen in the range of approximately 0.8 to 2 atomic % (FIG. 6).

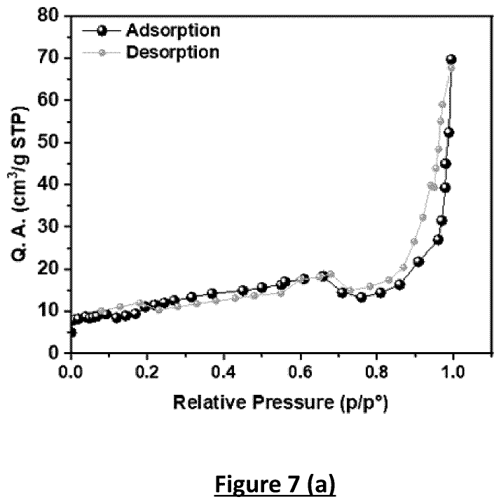

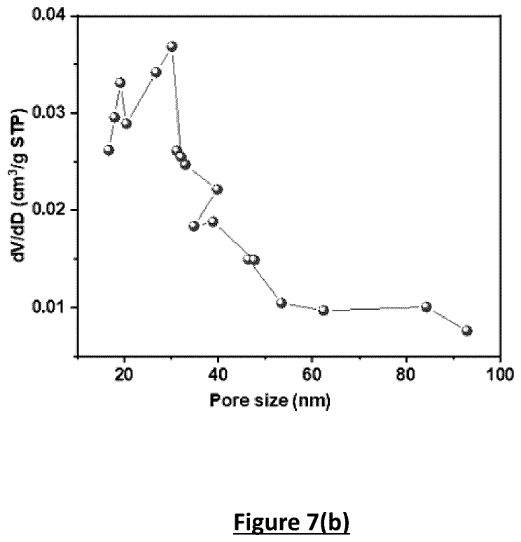

FIG. 7 (a) illustrates Adsorption and desorption theorems for the animal's dung derived ACNPs in accordance with an embodiment of the present disclosure. FIG. 7 (b) pore size measurement for the animal's dung derived ACNPs in accordance with an embodiment of the present disclosure. FIG. 7 illustrates (a) Adsorption and desorption theorems and (b) pore size measurement for the animal's dung derived ACNPs in accordance with an embodiment of the present disclosure.

### Brunauer-Emmett-Teller (BET) Analysis

Surface Area Measurement: One of the characteristics of the activated carbon particles used in this innovation is their relatively expansive surface area. The activated carbon particles have a Brunauer-Emmett-Teller (BET) surface area that varies between roughly 1,100 m²/g and 2,100 m²/g in one variant. The BET surface area of the activated carbon particles in an additional variant range from 1100 to 2000 m²/g. The activated carbon particles in an alternate variant possess a BET surface area ranging from 15500 to 2,300 m²/g. As previously stated, the activating agent and the ratio of carbon precursor to the material can have a significant impact on the surface area. Opting for more potent activating agents or increasing the quantity of activating agents in comparison to precursors typically leads to greater surface areas (FIG. 7a).

Pore-analysis: The animal's dung derived activated carbon particles possessed 3-5 nm mesopores diameter, as well as micropores with dimensions less than 4 nm. The porosity of the activated carbon particles in this invention can be assessed using various methods, in addition to the surface area, which falls within the range of approximately 950 m²/g to 1940 m²/g (FIG. 7b).

The present disclosure seeks to provide efficient approach to prepare activated carbon from animal dung.

The present disclosure also discloses the inexpensive and eco-friendly method for the preparation of activated carbon from animal dung.

The present disclosure also discloses the production of high-quality activated carbon with desirable features including controllable D- and G-band ratio and appropriate N % content.

The present disclosure also discloses the feasibility of the proposed method to be utilized at large scale for the production of activated carbon.

1M NaOH is used as an activating agent, and 1M HCl for washing. Although other reports have reported the methods using KOH/NaOH for the preparation of activated carbon from caw's dung, they used different approaches and different % of these activating agents.

The specific weight/volume percentage ratio of ingredients used here are; Animal Dung: 75 grams (100% by weight of the initial sample); 1M NaOH (1.2 Litre); 1M HCl (500 mL).

Chemical activation refers to the use of a chemical agent. In this invention, 1M NaOH solution is used to treat the cow dung before it undergoes pyrolysis. The NaOH serves as an activator, which helps to break down the organic matter in the dung, promoting the development of a more porous structure during the subsequent heating process. The chemical activation step is crucial because it enhances the porosity and surface area of the final activated carbon product by facilitating the partial decomposition of the material and making it more conducive to forming the desired porous structure during pyrolysis.

This chemical treatment occurs before the material is heated (pyrolyzed), and it typically makes the carbonization process more efficient, leading to a higher-quality activated carbon. In this method, the dung particles are soaked in the NaOH solution for 5 hours, allowing for the chemical agent to penetrate and interact with the material, which is different from simple thermal activation where only heat is used.

All the necessary technical parameters of every step like temperature, pressure, time, etc. are given below—

### (i) Cow Dung Drying and Washing

Initially, fresh cow dung is collected, and dried at 110° C. for 12 hr, followed by washing with distilled water, and then dried at 110° C. for 12 hr to remove any moisture and impurities.

### (ii) Attrition Milling, Sieving, and Drying

The dried cow dung is subjected to mechanical processing. First, it is ground in an attrition mill at 70° C. to break it down into smaller particles. Then, it is sifted through a sieve with a mesh size of 400 μm to standardize the particle size. The sieved material is then dried again at 110° C. for 5 hr to ensure it is moisture-free before further processing.

(iii) Carbonization

The prepared, dried, and sieved cow dung is subjected to carbonization at 700° C. for 120 min to convert the organic material into a carbon-rich structure. This process takes place in an N₂ environment to prevent combustion and ensure controlled thermal degradation.

### (iv) Chemical Activation

After carbonization, the resulting material is treated with a chemical activation process using an aqueous NaOH solution (1M, 16% by weight relative to the dung). The obtained material was soaked in the NaOH solution for 5 hours, allowing for the chemical agent to penetrate and interact with the material. The NaOH acted to further open up the pore structure of the material, enhancing its surface area and adsorption capacity.

### (v) Pyrolysis (Post-Chemical Activation)

The activated sample undergoes light and humidity exposure and then pyrolysis again at 800° C. for 150 min in the presence of an N₂ environment to further develop the carbon structure and enhance the material's properties. This treatment helped in removing volatile compounds, stabilizing the carbon structure, and refining the pore structure.

### (vi) Washing, Drying, and Crushing

After pyrolysis, the resulting activated carbon material is washed with 1M HCl (16% by weight relative to dung) to remove any residual chemical agents (NaOH and inorganic residues) and impurities. It is then dried at 110° C. overnight and crushed to achieve a fine, consistent powder for storage or further use.

TABLE
Comparison of the parameters of the prepared activated
carbon in this invention with others

| Caw's Dung | | | | | |
|---|---|---|---|---|---|
| Derived | | | | | |
| Activated | | | | | |
| Carbon | Morphology | Surface | | I_{D}/I_{G} | |
| Materials | and Size | Area | Pore size | Ratio | N % Content |
| ACDC | Highly | 1984 m² g⁻¹ | below 2 | | 2-3 |
| | irregular, rough | | nm | | |
| | surface and 1- | | | | |
| | 10 μm | | | | |
| CDC | Amorphous | 4000-12000 | | 1.23 | |
| | | m² g⁻¹ | | | |
| CM-DTHCA | | 1955 m² g⁻¹ | | | |
| cattle- | porous and | 300-1800 m² | 2-3 nm | | 0.2-2.5 |
| manure- | more complex | g⁻¹ | | | |
| compost | surface | | | | |
| (CMC) based | structure. | | | | |
| activated | | | | | |
| carbons | | | | | |
| Activated | Spherical & 20- | 1100 to 2000 | 3-5 nm | 1.7 | 0.8 to 2 |
| Carbon | 30 nm diameter | m² g⁻¹ | | | |
| Nanoparticles | | | | | |

Inexpensive and Eco-Friendly Synthesis Method: The invention provides a cost-effective and eco-friendly method to synthesize activated carbon on a large scale.

Controlled D- and G-Band Ratios: Because of involvement of chemical step after pyrolysis and post pyrolysis steps, this invention enables the precise control over the proportion of D-band (sp³-hybridized carbon, disordered phase) and G-band (sp²-hybridized carbon, graphitic phase) in the activated carbon. This is important because the D-band and G-band ratios are crucial for determining the electronic properties and reactivity of the carbon materials. Existing methods might not offer such precise control over these key parameters.

High N-Atomic %: The activated carbon synthesized through this method boasts an impressive nitrogen (N) content ranging from 0.8% to 2 atomic %, a key feature that could significantly enhance its performance in applications such as catalysis and energy storage. Unlike conventional methods, which typically involve traditional pyrolysis and washing with strong acids—processes that often lead to a considerable loss of nitrogen content—our approach preserves the material's nitrogen levels, thereby offering a more stable and efficient solution for advanced applications.

High Surface Area: Because of involvement of chemical step after pyrolysis and post pyrolysis steps, our approach is unique and useful to prepare highly porous activated carbon material, having high surface area, ranging from approximately 1100 m²/g to 2000 m²/g. A higher surface area is beneficial for applications in energy storage, adsorption, and catalysis.

Narrow Pore Size Distribution: The average pore width of the synthesized activated carbon material is in the range of about 3-5 nm, suggesting that the particles have a narrow and controlled pore size distribution, which is essential for optimized performance in various applications.

The terms “controllable D- and G-band ratio” and “appropriate N % content” refer to specific characteristics of the activated carbon materials that are crucial for determining their physical and chemical properties, which are important for their performance in various applications, particularly in energy storage, catalysis, and environmental sectors.

### (i) Controllable D- and G-Band Ratio

The D- and G-bands refer to specific vibrational modes in the Raman spectra of carbon materials, and they provide important insights into the material's structure as below—

D-Band (Disordered Band): This band corresponds to the vibrations of carbon atoms in disordered regions of the material, specifically the sp3-hybridized carbon atoms (i.e., carbon atoms that form single bonds and are not part of a graphitic structure). The D-band is associated with defects or irregularities in the material. A higher intensity of the D-band typically indicates more disorder or defects in the structure.

G-Band (Graphitic Band): This band corresponds to the vibrations of carbon atoms in a graphitic (sp2-hybridized) structure, where the carbon atoms are part of a stable hexagonal lattice (like in graphite). The G-band represents the ordered graphitic regions within the material.

The D-/G-band ratio is a measure of the relative amount of disorder (sp3 hybridization) to order (sp2 hybridization) in the carbon structure. A higher D-band intensity relative to the G-band intensity indicates more disorder (more defects), while a higher G-band intensity relative to the D-band indicates a more ordered graphitic structure.

Controllable D- and G-band ratio means that the synthesis method allows for adjusting the ratio between the disordered and graphitic phases in the activated carbon materials, allowing for tailored material properties. For example, for certain applications, a higher degree of disorder might be desired for higher reactivity, while a more ordered structure might be preferred for conductivity or stability.

### (ii) Appropriate N % (Nitrogen Atomic Percentage) Content

The N % content refers to the amount of nitrogen atoms incorporated into the activated carbon material's structure, expressed as a percentage of the total atomic composition. Nitrogen can be incorporated into the structure during the synthesis process, either by introducing nitrogen-containing precursors or through controlled doping.

The caw's dung is used, which have organic compounds such as proteins, amino acids, and urea (acted as C as well as N source) to prepare activated carbon. The appropriate N % content means that the amount of nitrogen is controlled to achieve the desired properties for a given application. In this invention, N-content in activated carbon was found to be in a controlled range (such as 0.8-2 atomic %) to balance its effects without overloading the structure, which could negatively affect performance.

The proposed method for preparing activated carbon from cow dung lies in several key distinctions compared to previously reported methods. Unlike traditional activation processes, which typically use a singular activation agent or a standardized temperature range, this method employs a dual activation approach-utilizing both chemical activation with NaOH and a unique post-activation treatment involving exposure to light and humidity. This additional step enhances the pore development during pyrolysis, potentially leading to activated carbon with superior surface area and porosity. Furthermore, the use of a precise 400 μm particle size after manual crushing and sieving, along with a controlled impregnation period of 5 hours, offers more uniform treatment compared to other methods that may lack such fine control over particle size and activation duration.

Additionally, the process incorporates a detailed washing step with 1M HCl to remove residual activating agents and inorganic impurities, ensuring a high-quality final product with minimal contaminants. The combination of these steps—chemical activation, light and humidity exposure, and a thorough washing procedure—distinguishes this approach from other methodologies reported in the literature, where such an integrated series of treatments is rarely seen. This method's careful balance of activation, pyrolysis conditions (specifically 700-800° C. under nitrogen), and subsequent purification provides an innovative, efficient pathway for the production of activated carbon with potentially enhanced adsorptive properties.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method for producing activated carbon material from cow dung, comprising:
a) drying cow dung at a temperature of about 110° C. for about 12 hours, followed by washing with distilled water and subsequent drying at about 110° C. for about 12 hours;
b) attrition milling the dried cow dung at a temperature of about 70° C.;
c) sieving the milled cow dung through a sieve with a mesh size of about 400 μm;
d) drying the sieved cow dung at a temperature of about 110° C. for about 5 hours;
c) carbonizing the dried and sieved cow dung at a temperature of about 700° C. for about 120 minutes in a nitrogen (N₂) environment;
f) chemically activating 75 grams carbonized material by soaking in 1.2 litre of an aqueous sodium hydroxide (NaOH) solution for about 5 hours;
g) pyrolyzing the chemically activated material at a temperature of about 600-800° C. for about 150 minutes in an N₂ environment;
h) washing 75 grams pyrolyzed material with about 500 mL hydrochloric acid (HCl) solution;
i) drying the washed material at a temperature of about 110° C. overnight; and
j) crushing the dried material to obtain activated carbon material, wherein the attrition milling in step (b) breaks down the dried cow dung into smaller particles, wherein during the drying step of cow dung in step (a), the drying is carried out in a programmable convection-IR hybrid chamber equipped with dual spectral IR emitters operating in the range of 2-10 μm, wherein the chamber includes a capacitive moisture sensor and a Fourier-transform infrared (FTIR) reflectance probe that continuously monitor the internal moisture desorption kinetics, and wherein a thermal model-based PID control loop regulates emitter power levels to maintain an exponential desorption curve, such that drying is halted only when the rate of moisture removal stabilizes below 0.05% per minute over a rolling 10-minute interval, and wherein prior to step (a), the cow dung is subjected to a microbial pre-treatment process involving aerobic fermentation with lignin-degrading microbial consortia, maintained in a controlled bioreactor at 37° C. and 60% relative humidity for 72 hours, wherein the pre-treatment breaks down lignocellulosic compounds and reduces bound nitrogen and sulfur content; and wherein the sieving in step (c) comprises a two-pass fluidized-bed air classifier integrated with an electrostatic pre-separation unit, wherein said classifier generates a low-turbulence laminar airflow directed at an angle of 25 degrees to horizontally suspended cow dung particles, allowing separation of fragments based on aerodynamic drag coefficients, and wherein the classifier includes a programmable material rejection gate that routes oversized biofibers to a secondary micronization loop without manual intervention.

2. The method of claim 1, wherein 94% of the carbonized material is mixed with 16% of the aqueous sodium hydroxide (NaOH) solution for chemical activation, whereas 94% of the pyrolyzed material is mixed with 16% of the hydrochloric acid (HCl) solution for washing, and wherein the nitrogen gas flow rate is approximately 70 mL/min.

3. The method of claim 1, wherein the microbial consortia include selectively cultured strains of Phanerochaete chrysosporium and Trametes versicolor, and wherein microbial activity is monitored in real-time using a dissolved oxygen probe, and the degradation rate is computed using UV-Vis absorbance spectra at 280 nm and 320 nm, which govern the transition to the drying step upon reaching a lignin degradation threshold of 65%.

4. The method of claim 1, wherein the attrition milling in step (b) is conducted in a reactive atmosphere chamber infused with controlled humidity between 10% and 15% relative humidity, wherein said humidity acts as a dispersion medium to prevent electrostatic aggregation of cellulose-fiber-rich cow dung particles, and wherein the attrition mechanism includes a dual-rotor vortex shear impeller with non-linear speed ramping that initiates with 50 rpm for pre-loosening and scales to 300 rpm cyclically, with embedded torque sensors dynamically adjusting the milling intensity based on real-time particle resistance to achieve energy-efficient comminution while maintaining biopolymeric residue stability.

5. The method of claim 1, wherein between step (d), the sieved and dried cow dung particles are subjected to low-temperature plasma surface pre-treatment using oxygen plasma at 30 W power for 3 minutes in a vacuum chamber at 0.2 mbar, wherein the plasma etches surface hydrocarbons and introduces surface oxygen functionalities to promote controlled nucleation sites for graphitization during the carbonization stage.

6. The method of claim 1, wherein the carbonization step (e) further comprises a staged injection of volatile gas condensates recovered from earlier carbonization batches through a catalytic reformer back into the reactor chamber as a reducing agent, thereby creating a reactive-carbon atmosphere which enhances surface porosity via in-situ etching during the 700° C. thermal soak phase, and wherein the carbonization reactor includes real-time pore-size monitoring using non-invasive NIR sensors that trigger modulation of the inert gas flow rate to preserve target micropore geometries, and wherein during step (c), the carbonization atmosphere includes staged nitrogen-carbon dioxide hybrid flow wherein nitrogen at 70 mL/min is progressively replaced with carbon dioxide at up to 30 mL/min during the final 30 minutes of carbonization, such that partial gasification occurs at high temperatures, enhancing microporosity through physical activation while preserving bulk carbon structure.

7. The method of claim 1, wherein in step (f), the chemical activation is performed via a semi-continuous percolation reactor setup wherein sodium hydroxide solution is statically soaked and also cyclically recirculated through the carbonized mass using a peristaltic flow mechanism for 5 hours, wherein the percolation cycle is dynamically tuned by an inline impedance-based porosity sensor that adjusts the NaOH perfusion rate based on the resistivity feedback of the carbon bulk, and wherein the aqueous sodium hydroxide used in step (f) is recycled from prior activation cycles using a membrane-based nanofiltration system operating at 4 bar, wherein the spent activation solution is first neutralized to pH 7, then filtered through a polyamide spiral-wound membrane with 90% retention rate, and wherein recovered NaOH solution is re-concentrated to 3M using rotary vacuum evaporation before reuse.

8. The method of claim 1, wherein the pyrolysis in step (g) is executed using a controlled dual-zone induction furnace, wherein the upper temperature zone is maintained at 800° C. and the lower zone at 600° C., and wherein the chemically activated mass is oscillated vertically via a programmable elevator platform between zones in a sinusoidal time-heat profile to prevent thermal saturation, thus promoting anisotropic graphitic plane expansion and selective volatile removal, and
wherein the pyrolysis chamber in step (g) includes a rotating crucible with a thermally insulated double-walled design, wherein the inner wall is made of alumina and equipped with embedded thermocouples at three axial points, and wherein rotational movement at 4 rpm facilitates uniform exposure of the material to heating zones, while thermal gradient data from thermocouples is fed to a PID controller which modulates the external induction coil frequency to maintain ±5° C. temperature uniformity across the sample.

9. The method of claim 1, wherein the hydrochloric acid washing in step (h) is performed in a multi-stage pH-gradient dialysis reactor, wherein the pyrolyzed carbon is successively exposed to decreasing molarity gradients of HCl from 1.5 M to 0.1 M over four zones, each zone separated by semi-permeable flow partitions, and wherein ionic exchange and residual alkali removal are enhanced by inductively coupled mild ultrasonication (40 kHz), ensuring that metallic impurities are removed without disrupting the micro/mesoporous framework established during activation, and wherein step (h) includes a secondary neutralization stage after HCl washing, wherein the acid-treated carbon is soaked in a 0.05M sodium bicarbonate solution for 15 minutes to neutralize residual surface acidity, followed by centrifugation at 6000 rpm for 10 minutes to remove soluble salts, ensuring stability of the final activated carbon in pH-sensitive applications, and wherein the hydrochloric acid washing step (h) is executed through a multi-stage peristaltic flow-through column system wherein the pyrolyzed carbon is packed into vertical quartz tubes and 0.5M hydrochloric acid is passed under gravity at a constant flow rate of 2 mL/min, and wherein each stage includes a temperature-controlled zone maintained at 50° C. to increase ionic diffusion rates.

10. The method of claim 1, wherein drying in step (i) is carried out in a hybrid thermal-vacuum infrared drying unit wherein the material is loaded onto rotating quartz platforms subjected to 110° C. infrared irradiation cycles under 15 mbar vacuum, and wherein temperature is regulated not just by time but by real-time dielectric loss factor measurements of the material, which indicate residual moisture presence and dynamically adjust the IR exposure, preventing heat-induced sintering or porosity loss, and wherein during step (i), the drying chamber atmosphere is purged with pre-dried nitrogen gas at a flow rate of 100 mL/min to displace residual acidic vapors and moisture during vacuum drying, and wherein the final moisture level is verified using a gravimetric method in combination with near-infrared moisture analysis at 1450 nm before proceeding to crushing, and wherein the final drying step (i) of the washed pyrolyzed carbon is carried out in a vacuum-assisted rotary tray dryer wherein the trays are heated from below using a glycol-heated base to maintain 110° C. and simultaneously rotated at 1 RPM to prevent particulate settling, and wherein a capacitive humidity sensor installed in the exhaust path is coupled with a feedback control unit that modifies the vacuum level between 50 and 100 mbar in cycles.

11. The method of claim 1, wherein the crushing in step (j) is conducted in a cryogenic grinding chamber where the dried material is cooled to −80° C. using liquid nitrogen vapor prior to impact pulverization, and wherein the pulverized material is simultaneously subjected to vortex air classification that segregates ultrafine particles (<20 μm) for immediate collection while recycling coarser fragments, and wherein particle surface defects introduced during cryo-pulverization are passivated by brief argon plasma exposure to stabilize reactive edges for downstream functionalization, and wherein the final crushing in step (j) is followed by a de-agglomeration process using acoustic resonance dispersion at a frequency of 28 kHz applied in a sealed acoustically coupled chamber, wherein resonance-induced nodal shear forces break soft agglomerates without mechanical impact, and wherein a continuous air classifier integrated inline ensures only de-agglomerated particles below 25 μm are retained for final collection.

12. The method of claim 1, wherein the wherein the crushing in step (j) is followed by a pneumatic dispersion classification stage wherein the powdered activated carbon is subjected to a turbulent air vortex classifier at a velocity of 4 m/s, wherein the classifier includes triboelectric charge sensors that detect fine particle agglomeration, and based on the surface charge accumulation, the system applies differential electrostatic fields to disaggregate cohesive clusters and ensure that only particles below 10 μm with specific surface area above 1000 m²/g, as validated through BET analysis, are collected for final packaging.

13. The method of claim 1, further comprising dynamically managed transition of cow dung from a lignocellulosic matrix to a porous carbonaceous structure by a staged heat-transfer profile generated through a distributed zone-controlled reactor architecture, wherein each zone employs embedded micro-thermocouple arrays calibrated for differential heat absorption of semi-organic substrates, and wherein the time-temperature profile is computationally segmented to ensure separation of volatile release and aromatization phases to reduce pore occlusion during in-situ carbon ring formation, and wherein the hydroxide activation phase is driven by a diffusion-controlled process regime modeled by Fick's second law, and wherein the system utilizes an electrochemical impedance spectroscopy (EIS) module interfaced with a fluidized bed reactor to assess real-time penetration depth of Na⁺ and OH⁻ ions into the carbon matrix based on Warburg diffusion coefficients, and wherein the activation reaction is programmatically terminated once impedance-phase angle shift falls below 5° across frequencies between 100 Hz and 1 kHz, indicating saturation of active binding sites.

14. The method of claim 1, wherein porosity development during the thermal treatment phase is tailored by regulating surface catalytic interactions through the timed introduction of trace vaporized iron (III) chloride (FeCl₃) into the processing chamber, wherein the vapor concentration is held between 100-300 ppm during the peak thermal soak and adsorbs selectively onto aliphatic chain residues, catalyzing their cyclization into extended sp2 carbon domains, and wherein the drying of cow dung is enhanced by applying a vacuum-assisted convective drying process, wherein the cow dung is placed in a drying chamber maintained at 110° C. under a vacuum pressure of 200 mbar, and wherein a horizontal laminar airflow at 1.5 m/s is circulated across the surface to accelerate moisture evaporation and prevent crust formation.

15. The method of claim 1, wherein the attrition milling of the dried cow dung is followed by a particle shape conditioning step using a vibratory ball mill for a duration of 20 minutes, wherein spherical ceramic grinding media of 3 mm diameter is used to reduce surface asperities and improve particle sphericity, and wherein the carbonized material is pre-treated with deionized water rinsing for 10 minutes before soaking in the aqueous sodium hydroxide (NaOH) solution, and wherein said rinsing step removes loosely bound tars and ashes that would otherwise hinder NaOH penetration.

16. The method of claim 1, wherein the pyrolyzed material is subjected to a post-pyrolysis thermal annealing phase at 850° C. for an additional 30 minutes in a nitrogen environment, during which time residual metallic or carbonate impurities are thermally decomposed and volatilized, thereby enhancing the structural ordering of the graphitic domains and increasing the electrical conductivity and surface reactivity of the activated carbon, and wherein the hydrochloric acid (HCl) washing step is carried out in a pulsating flow setup wherein the acid is delivered in intermittent flow cycles at 2-minute intervals over a total exposure time of 30 minutes, and wherein the pulsation frequency and duration are optimized to induce microfluidic turbulence within the porous carbon.

17. The method of claim 1, wherein the final crushing of the dried activated carbon material is conducted under cryogenic conditions at −120° C. using a nitrogen-cooled impact mill, wherein the brittleness induced by cryogenic treatment leads to clean fracturing of the carbon structures without pore wall collapse, wherein each thermal treatment step, including carbonization and pyrolysis, is monitored using in-situ infrared thermography coupled with emissivity correction algorithms specific to organic carbonaceous materials, and wherein detected temperature deviations greater than ±2° C. from target setpoints are used to trigger automated PID-based heater adjustments to maintain thermal homogeneity across the sample bed, and wherein the chemical activation solution is regenerated and reused in subsequent batches by recovering excess sodium hydroxide through membrane filtration using a cross-flow nanofiltration system, wherein carbon fines are separated by size exclusion and the filtrate is analyzed for residual hydroxide concentration before reconstitution to target molarity.
